(19) United States
(12) Patent Application Publication
(10) Pub. No.: US 2005/0235428 A1
(43) Pub. Date: Oct. 27, 2005

(54) Use of metal complex compounds as oxidation catalysts

(76) Inventors: Frank Bachmann, Freiburg (DE); Josef Dannacher, Strasse (CH); Gunther Schlingloff, Riehen (CH); Menno Hazenkamp, Riehen (CH); Grit Hansler, Neuenburg (DE); Kaspar Hegetschweiler, St. Ingbert (DE); Uwe Heinz, Saarlouis (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/499,390

(22) PCT Filed: Dec. 16, 2002
(86) PCT No.: PCT/EP02/14318

§ 371 Date: Jun. 22, 2005

(30) Foreign Application Priority Data
Dec. 21, 2001 (EP) 01811263.1

(51) Int. Cl. C11D 3/00; D06M 10/00

(52) U.S. Cl. 8/115.51; 510/302

(57) ABSTRACT

The use of metal complexes of compounds of formula I 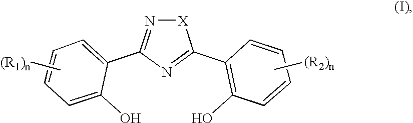 wherein the general symbols are as defined in claim 1, as oxidation catalysts.

The present invention relates to the use of metal complex compounds as oxidation catalysts. The present invention relates also to formulations comprising such metal complex compounds, to novel metal complex compounds and to a method of catalysing oxidations, wherein at least one complex compound according to the invention is added to the oxidising agent.

The metal complex compounds are used especially for improving the action of peroxides, for example in the treatment of textile material, without at the same time causing any appreciable damage to fibres and dyeings.

Peroxide-containing bleaching compositions have been used in washing and cleaning processes for some time. They have an excellent action at a liquor temperature of 90° C. and above, but their performance noticeably decreases with lower temperatures. It is known that various transition metal ions, added in the form of suitable salts, or coordination compounds containing such cations, catalyse the decomposition of H₂O₂. In that way it is possible to increase the bleaching action of H₂O₂, or of precursors that release H₂O₂, or of other peroxo compounds, the bleaching action of which is unsatisfactory at lower temperatures. Particularly significant for practical purposes are those combinations of transition metal ions and ligands the peroxide activation of which is manifested in an increased tendency towards oxidation in respect of substrates and not only in a catalase-like disproportionation. The latter activation, which tends rather to be undesirable in the present case, could impair the bleaching effects of H₂O₂ and its derivatives which are insufficient at low temperatures.

In respect of H₂O₂ activation having effective bleaching action, mononuclear and polynuclear variants of manganese complexes with various ligands, especially with 1,4,7-trimethyl-1,4,7-triazacyclononane and optionally oxygen-containing bridge ligands, are currently regarded as being especially effective. The catalysts disclosed e.g. in WO-A-01/64697 have adequate stability under practical conditions and, with Mnⁿ⁺, contain an ecologically acceptable metal cation, but their use is unfortunately associated with considerable damage to dyes and fibres.

The aim of the present invention was, therefore, to provide improved metal complex catalysts for oxidation processes which fulfil the above demands and, especially, improve the action of peroxy compounds in an extremely wide range of fields of use without giving rise to any appreciable damage.

The invention accordingly relates to the use of metal complex compounds of formula I 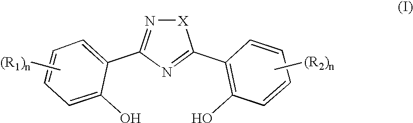
wherein
X is oxygen or 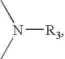
R₁ and R₂ each independently of the other are halogen, hydroxy, cyano, nitro, 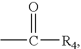
   —SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 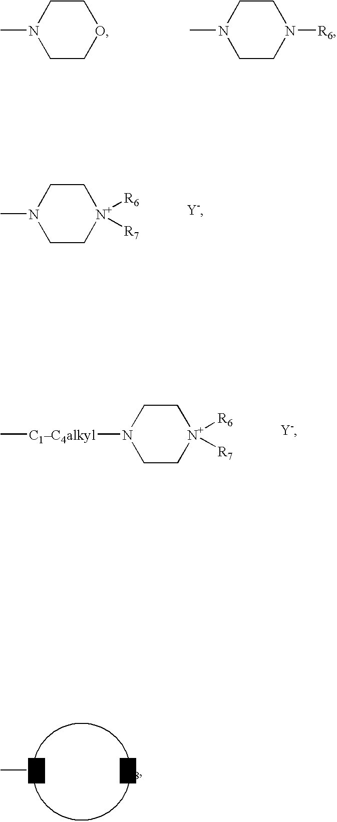
   di(C₁-C₄acyl)amino, C₁-C₈alkyl, C₁-C₈alkoxy or C₁-C₈alkanoyl, R₃ is hydrogen, C₁-C₁₂alkyl, phenyl or 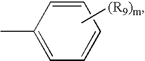
R₄ is —OR₁₀, —NH₂, —NHR₁₁, 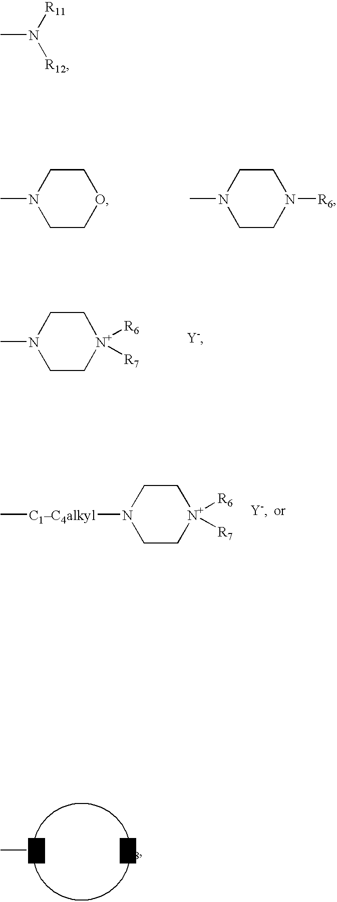
R₅ is —OR₁₀, C₁-C₈alkyl or —NH₂,
R₆ is hydrogen, C₁-C₈alkyl or C₇-C₉phenylalkyl,
R₇ is hydrogen, C₁-C₈alkyl or C₇-C₉phenylalkyl,
R₈ is unsubstituted or C₁-C₄alkyl-substituted C₂-C₁₂alkylene,
R₉ is halogen, hydroxy, cyano, nitro, 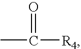
   —SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 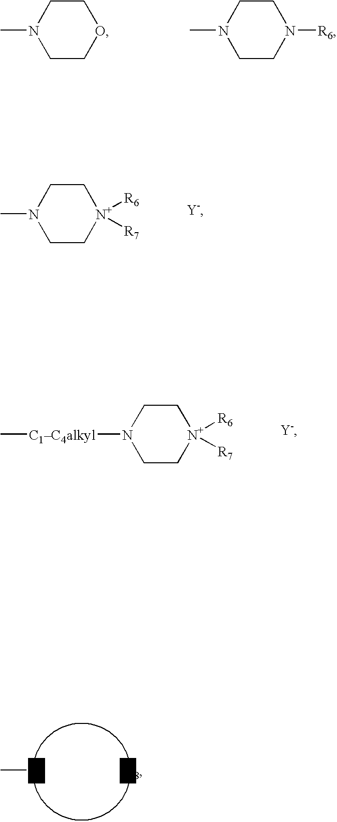
   di(C₁-C₄acyl)amino, C₁-C₈alkyl, C₁-C₈alkoxy or C₁-C₈alkanoyl,
R₁₀ is hydrogen, sodium or potassium,
R₁₁, and R₁₂ each independently of the other are C₁-C₈alkyl,
Y⁻ is a monovalent anion,
m is 1 or 2, and
n is 0, 1, 2 or 3;
   as oxidation catalysts.

Halogen is, for example, fluorine, chlorine, bromine or iodine. Chlorine is preferred.

Fluoro-substituted C₁-C₈alkyl is a branched or unbranched radical, for example fluoromethyl, difluoromethyl, trifluoromethyl or pentafluoroethyl. Trifluoromethyl is preferred.

Fluoro-substituted C₁-C₈alkoxy is a branched or unbranched radical, for example fluoromethoxy, difluoromethoxy, trifluoromethoxy or pentafluoroethoxy. Trifluoromethoxy is preferred.

Chloro-substituted C₁-C₈alkyl is a branched or unbranched radical, for example chloromethyl, dichloromethyl, trichloromethyl or pentachloroethyl. Chloromethyl and trichloromethyl are preferred.

Chloro-substituted C₁-C₈alkoxy is a branched or unbranched radical, for example chloromethoxy, dichloromethoxy, trichloromethoxy or pentachloroethoxy. Trichloromethoxy is preferred.

C₇-C₉-Phenylalkoxy is, for example, benzyloxy, α-methylbenzyloxy or α,α-dimethylbenzyloxy. Benzyloxy is preferred.

Alkylamino having up to 8 carbon atoms is a branched or unbranched radical, for example methylamino, ethylamino, propylamino, isopropylamino, n-butylamino, isobutylamino or tertbutylamino.

Acylamino having up to 8 carbon atoms is a branched or unbranched radical, for example formylamino, acetylamino, propionylamino, butanoylamino, pentanoylamino, benzoylamino or octanoylamino. Acetylamino is preferred.

Di(C₁-C₄alkyl)amino also means that the two radicals each independently of the other are branched or unbranched, for example dimethylamino, methylethylamino, diethylamino, methyl-n-propylamino, methyl-isopropylamino, methyl-n-butylamino, methyl-isobutylamino, ethyl-isopropylamino, ethyl-n-butylamino, ethyl-isobutylamino, ethyl-tert-butylamino, di-isopropylamino, isopropyl-n-butylamino, isopropyl-isobutylamino, di-n-butylamino or di-isobutylamino.

Di(C₁-C₄acyl)amino also means that the two radicals each independently of the other are branched or unbranched, for example diacetylamino, acetyl-propionylamino, dipropionylamino or dibutanoylamino.

Alkyl having up to 12 carbon atoms is a branched or unbranched radical, for example methyl, ethyl, n-propyl, isopropyl, n-butyl, sec-butyl, isobutyl, tert-butyl, pentyl, hexyl, heptyl, octyl, nonyl, decyl, undecyl or dodecyl.

Alkoxy having up to 8 carbon atoms is a branched or unbranched radical, for example methoxy, ethoxy, propoxy, isopropoxy, n-butoxy, isobutoxy, pentyloxy, isopentyloxy, hexyloxy, heptyloxy or octyloxy.

Alkanoyl having up to 8 carbon atoms is a branched or unbranched radical, for example formyl, acetyl, propionyl, butanoyl, pentanoyl, hexanoyl, heptanoyl or octanoyl.

Unsubstituted or C₁-C₄alkyl-substituted C₂-C₁₂alkylene is a branched or unbranched radical, for example methylene, ethylene, propylene, trimethylene, tetramethylene, pentamethylene, hexamethylene, heptamethylene, octamethylene, decamethylene or dodecamethylene. C₂-C₈Alkylene, especially C₃-C₅alkylene, is preferred.

Metals suitable for the formation of metal complexes of compounds of formula I are, for example, iron, especially in oxidation states I to IV; manganese, especially in oxidation states II-V; titanium, especially in oxidation states III and IV; cobalt, especially in oxidation states I to III; nickel, especially in oxidation states I to III; and also copper, especially in oxidation states I to III.

Of interest is the use of metal complexes of compounds of formula I wherein
X is oxygen or

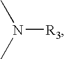

R₁ and R₂ each independently of the other are chlorine, bromine, hydroxy, cyano, nitro, 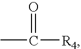
—SO₂R₅, trifluoromethyl, trifluoromethoxy; chloromethyl, trichloromethyl, trichloromethoxy, benzyloxy, amino, C₁-C₄alkylamino, C₁-C₄acylamino, di(C₁-C₄alkyl)amino, 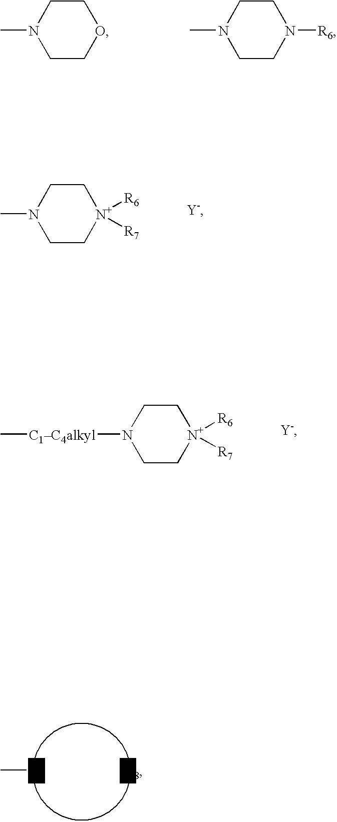
di(C₁-C₄acyl)amino, C₁-C₄alkyl, C₁-C₄alkoxy or C₂-C₄alkanoyl,
R₃ is hydrogen, C₁-C₈alkyl, phenyl or 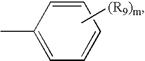
R₄ is —OR₁₀, —NH₂, —NHR₁₁, 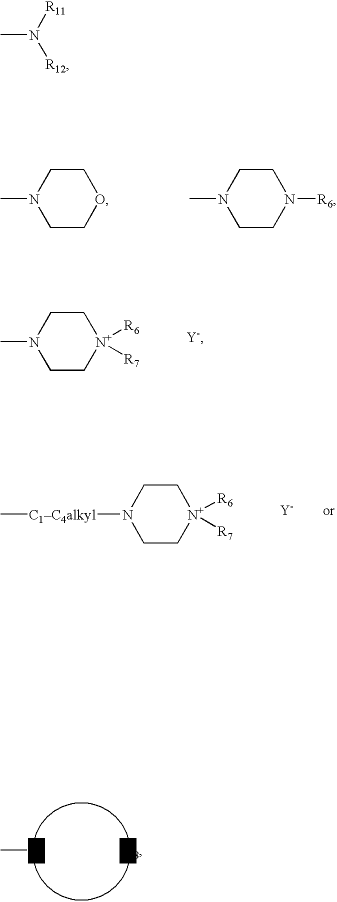
R₅ is —OR₁₀, C₁-C₄alkyl or —NH₂,
R₆ is hydrogen, C₁-C₄alkyl or benzyl,
R₇ is hydrogen, C₁-C₄alkyl or benzyl,
R₈ is C₂-C₈alkylene,
R₉ is fluorine, chlorine, bromine, hydroxy, cyano, nitro, 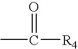
   —SO₂R₅, trifluoromethyl; trifluoromethoxy; chloromethyl, trichloromethyl, trichloromethoxy, benzyloxy, amino,
C₁-C₄alkylamino, C₁-C₄acylamino, di(C₁-C₄alkyl)amino, 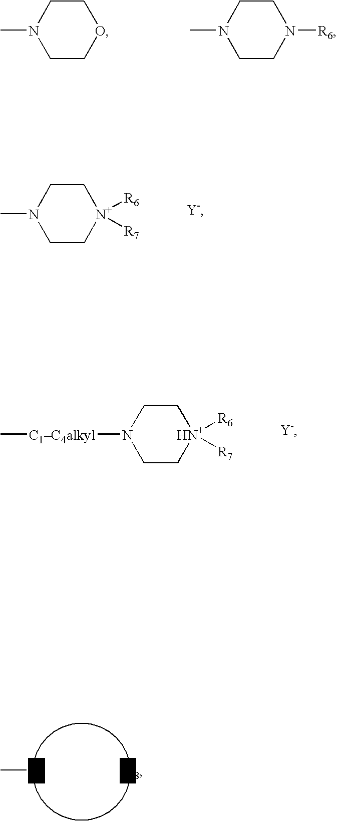
   di(C₁-C₄acyl)amino, C₁-C₄alkyl, C₁-C₄alkoxy or C₂-C₄alkanoyl,
R₁₀ is hydrogen, sodium or potassium,
R₁₁, and R₁₂ each independently of the other are C₁-C₄alkyl,
Y⁻ is halide, nitrate or carboxylate,
m is 1 or 2, and
n is 0, 1 or 2.

Of special interest is the use of metal complexes of compounds of formula I wherein
X is oxygen or 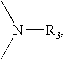
R₁ and R₂ each independently of the other are chlorine, hydroxy, cyano, 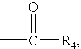
   —SO₂R₅, C₁-C₄acylamino, di(C₁-C₄alkyl)amino, 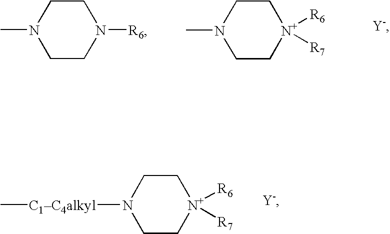
   di(C₁-C₄acyl)amino, C₁-C₄alkyl, chloromethyl, methoxy or C₂-C₄alkanoyl,
R₃ is hydrogen, C₁-C₈alkyl, phenyl or 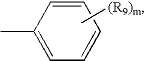
R₄ is —OR₁₀, —NH₂, —NHR₁₁ or 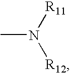
R₅ is —OR₁₀, methyl or —NH₂,
R₆ and R₇ each independently of the other are hydrogen, C₁-C₄alkyl or benzyl,
R₉ is chlorine, hydroxy, cyano, nitro, 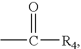
   —SO₂R₅ or methoxy,
R₁₀ is hydrogen, sodium or potassium,
R₁₁, and R₁₂ each independently of the other are C₁-C₄alkyl,
Y⁻ is chloride or carboxylate,
m is 1, and
n is 0 or 1.

Special preference is given to the use of metal complexes of compounds of formula I wherein

the metal is iron or manganese,

X is oxygen or 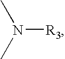
   and
R₃ is hydrogen, C₁-C₄alkyl, phenyl or 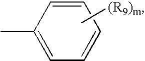
R₄ and R₅ are —OR₁₀,
R₉ is 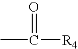
   or —SO₂R₅,
R₁₀ is hydrogen,
m is 1, and
n is 0.

Ligands of formula I are known in the literature or can be obtained analogously to known processes.

The preparation of the compounds of formula I is preferably carried out by reaction of a compound of formula II with a compound of formula III 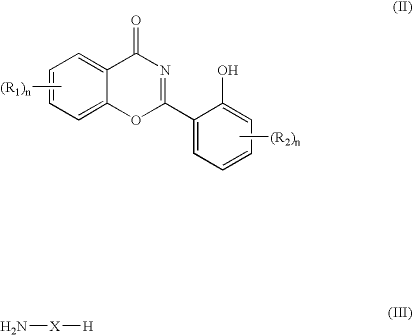
wherein R₁, R₂, n and X are as defined above.

The reaction is preferably carried out in a solvent, for example ethanol, by boiling for several hours under reflux.

Some of the metal complexes of compounds of formula I according to the invention are known and can be obtained analogously to known processes. They are obtained in a manner known per se by reacting at least one compound of formula I in the desired molar ratio with a metal compound, especially a metal salt, such as the chloride, to form the corresponding metal complex. The reaction is carried out, for example, in a solvent, such as water or a lower alcohol, such as ethanol, at a temperature of, for example, from 10 to 60° C., especially at room temperature.

The present invention relates also to the novel metal complexes of compounds of formula I 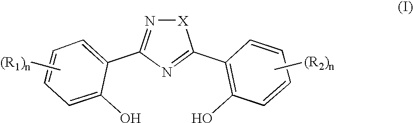
wherein
X is oxygen or 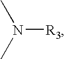
R₁ and R₂ each independently of the other are halogen, hydroxy, cyano, nitro, 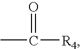
   —SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 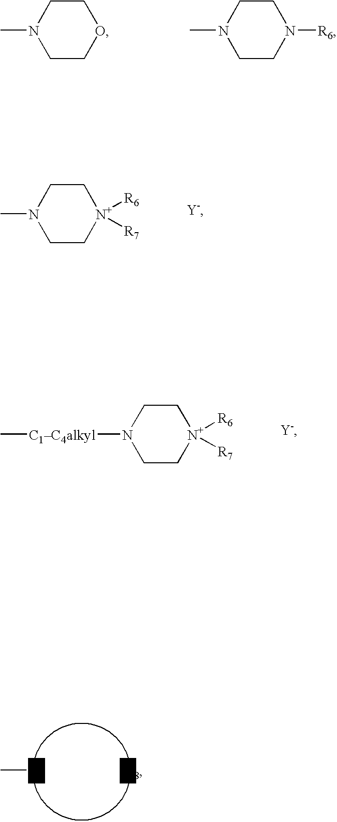
   di(C₁-C₄acyl)amino, C₁-C₈alkyl, C₁-C₈alkoxy or C₁-C₈alkanoyl,
R₃ is hydrogen, C₁-C₁₂alkyl, phenyl or 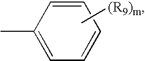
R₄ is —OR₁₀, —NH₂, —NHR₁₁, 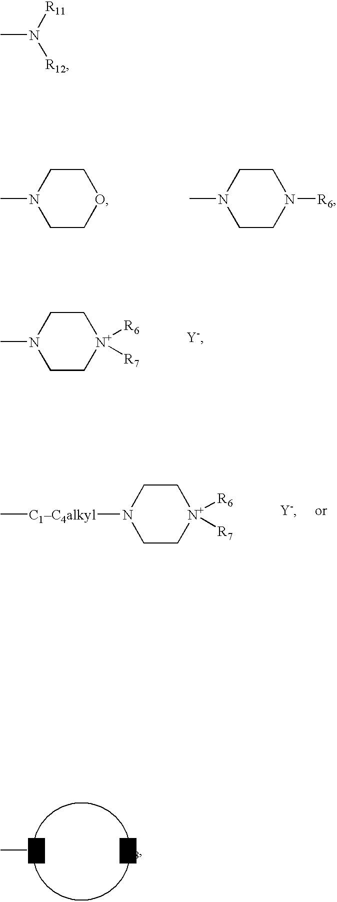
R₅ is —OR₁₀, C₁-C₈alkyl or —NH₂,
R₆ is hydrogen, C₁-C₈alkyl or C₇-C₉phenylalkyl,
R₇ is hydrogen, C₁-C₈alkyl or C₇-C₉phenylalkyl,
R₈ is unsubstituted or C₁-C₄alkyl-substituted C₂-C₁₂alkylene,
R₉ is halogen, hydroxy, cyano, nitro, 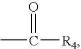
   —SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 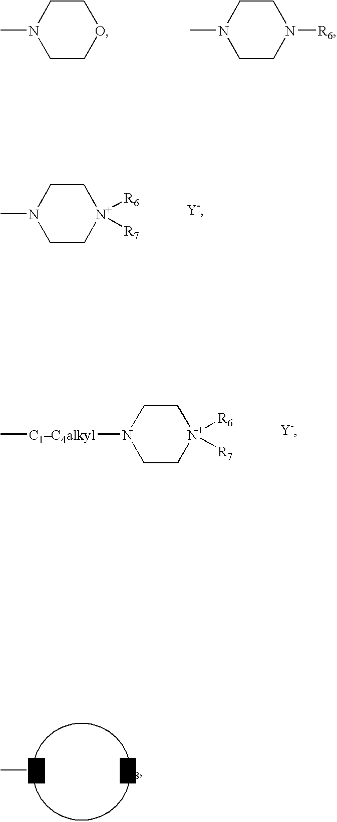
   di(C₁-C₄acyl)amino, C₁-C₈alkyl, C₁-C₈alkoxy or C₁-C₈alkanoyl,
R₁₀ is hydrogen, sodium or potassium,
R₁₁ and R₁₂ each independently of the other are C₁-C₈alkyl,
Y⁻ is a monovalent anion,
m is 1 or 2, and
n is 0, 1, 2 or 3.

Of special interest are the novel metal complexes of compounds of formula I wherein the metal is iron or manganese,
X is oxygen or 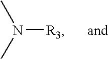
R₃ is hydrogen, C₁-C₄alkyl, phenyl or 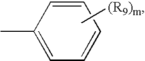
   R₄ and R₅ are —OR₁₀,
R₉ is 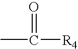
   or —SO₂R₅,
R₁₀ is hydrogen,
m is 1, and
n is 0.

The metal complexes of compounds of formula I are preferably used in washing, cleaning, disinfecting or bleaching compositions.

The metal complexes of compounds of formula I are preferably used together with peroxy compounds for the bleaching of spots or stains on textile material or for the prevention of redeposition of migrating dyes in the context of a washing process, or for the cleaning of hard surfaces, for example table- and kitchen-ware, glass, wall tiles or floor tiles. It is preferred to use aqueous formulations of the metal complexes of compounds of formula I for this purpose.

Of special interest is the use of metal complexes of compounds of formula I for the removal of stains caused by the action of molds (mold stains); use in washing and cleaning solutions having an antibacterial action; or as pretreatment agents for bleaching textiles.

Also of interest is the use of metal complexes of compounds of formula I as catalysts for selective oxidations in the context of organic synthesis.

A further use relates to the use of metal complexes of compounds of formula I as catalysts for reactions with peroxy compounds for bleaching in the context of paper-making. This relates especially to the bleaching of pulp, which can be carried out in accordance with customary processes. Also of interest is the use of metal complexes of compounds of formula I as catalysts for reactions with peroxy compounds for the bleaching of waste printed paper.

It should be emphasised that the metal complexes of compounds of formula I do not cause any appreciable damage to fibres and dyeings, for example in the bleaching of textile material.

Processes for preventing the redeposition of migrating dyes in a washing liquor are usually carried out by adding to the washing liquor, which contains a peroxide-containing washing composition, one or more metal complexes of compounds of formula I in an amount of from 0.1 to 200 mg, preferably from 1 to 75 mg, especially from 3 to 50 mg, per litre of washing liquor. It will be understood that in such an application, as well as in the other applications, the metal complexes of compounds of formula I can alternatively be formed in situ, the metal salt (e.g. manganese(II) salt, such as manganese(II) chloride) and the ligand being added in the desired molar ratios.

The present invention relates also to a washing, cleaning, disinfecting or bleaching composition, comprising
a) 0-50%, preferably 0-30%, of an anionic surfactant and/or of a non-ionic surfactant,
b) 0-70%, preferably 0-50%, of a builder substance,
c) 1-99%, preferably 1-50%, of a peroxide or a peroxide-forming substance, and
d) at least one metal complex of a compound of formula I in an amount which, in the liquor, gives a concentration of 0.5-50 mg/litre of liquor, preferably 1-30 mg/litre of liquor, when from 0.5 to 20 g/litre of the washing, cleaning, disinfecting or bleaching composition are added to the liquor; the percentages being in each case percentages by weight, based on the total weight of the composition.

The compositions preferably contain from 0.005 to 2% of a metal complex compound of formula 1, especially from 0.01 to 1% and preferably from 0.05 to 1%.

When the compositions according to the invention comprise a component (a), the amount thereof is preferably 1-50%, especially 1-30%.

When the compositions according to the invention comprise a component (b), the amount thereof is preferably 1-70%, especially 1-50%. Special preference is given to an amount of from 5 to 50% and especially an amount of from 10 to 50%.

Corresponding washing, cleaning, disinfecting or bleaching processes are usually carried out by using an aqueous liquor comprising a peroxide and from 0.1 to 200 mg of one or more metal complexes of compounds of formula I per litre of liquor. The liquor preferably contains from 1 to 30 mg of at least one metal complex of a compound of formula I per litre of liquor.

The composition according to the invention can be, for example, a peroxide-containing complete washing composition or a separate bleaching additive. A bleaching additive is used for removing coloured stains on textiles in a separate liquor before the clothes are washed with a bleach-free washing composition. A bleaching additive can also be used in a liquor together with a bleach-free washing composition.

The washing or cleaning composition according to the invention can be in solid or liquid form, for example in the form of a liquid, non-aqueous washing composition, comprising not more than 5% by weight water, preferably comprising from 0 to 1% by weight water, and, as base, a suspension of a builder substance in a non-ionic surfactant, e.g. as described in GB-A-2 158 454.

The washing or cleaning composition is preferably in the form of a powder or, especially, granules.

The latter can be prepared, for example, by first preparing an initial powder by spray-drying an aqueous suspension containing all the components listed above except for components (c) and (d), then adding the dry components (c) and (d) and mixing everything together. It is also possible to add component (d) to an aqueous suspension containing components (a) and (b), then to carry out spray-drying and finally to mix component (c) with the dry mass.

It is also possible to start with an aqueous suspension that contains components (a) and (b), but none or only some of the non-ionic surfactant. The suspension is spray-dried, then component (d) is mixed with the non-ionic surfactant and added, and then component (c) is mixed in in the dry state.

It is also possible to mix all the components together in the dry state.

The anionic surfactant can be, for example, a sulfate, sulfonate or carboxylate surfactant or a mixture thereof. Preferred sulfates are those having from 12 to 22 carbon atoms in the alkyl radical, optionally in combination with alkyl ethoxysulfates in which the alkyl radical has from 10 to 20 carbon atoms.

Preferred sulfonates are e.g. alkylbenzenesulfonates having from 9 to 15 carbon atoms in the alkyl radical. The cation in the case of anionic surfactants is preferably an alkali metal cation, especially sodium.

Preferred carboxylates are alkali metal sarcosinates of formula R—CO—N(R′¹)—CH₂COOM′¹ wherein R is alkyl or alkenyl having from 8 to 18 carbon atoms in the alkyl or alkenyl radical, R′¹ is C₁-C₄alkyl and M′¹ is an alkali metal.

The non-ionic surfactant can be, for example, a condensation product of from 3 to 8 mol of ethylene oxide with 1 mol of a primary alcohol having from 9 to 15 carbon atoms.

As builder substance there come into consideration, for example, alkali metal phosphates, especially tripolyphosphates, carbonates or hydrogen carbonates, especially their sodium salts, silicates, aluminosilicates, polycarboxylates, polycarboxylic acids, organic phosphonates, aminoalkylenepoly(alkylenephosphonates) or mixtures of those compounds.

Especially suitable silicates are sodium salts of crystalline layered silicates of the formula NaHSiₜO₂ₜ₊₁.p H₂O or Na₂SiₜO₂ₜ₊₁.p H₂O wherein t is a number from 1.9 to 4 and p is a number from 0 to 20.

Among the aluminosilicates, preference is given to those commercially available under the names Zeolite A, B, X and HS, and also to mixtures comprising two or more of those components.

Among the polycarboxylates, preference is given to polyhydroxycarboxylates, especially citrates, and acrylates and also copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid.

As peroxide component (c) there come into consideration, for example, the organic and inorganic peroxides known in the literature and available commercially that bleach textile materials at conventional washing temperatures, for example at from 10 to 95° C.

The organic peroxides are, for example, mono- or poly-peroxides, especially organic peracids or salts thereof, such as phthalimidoperoxycaproic acid, peroxybenzoic acid, diperoxydodecanedioic acid, diperoxynonanedioic acid, diperoxydecanedioic acid, diperoxyphthalic acid or salts thereof.

Preferably, however, inorganic peroxides are used, for example persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability.

The peroxides are added to the composition preferably by mixing the components, for example using a screw metering system and/or a fluidised bed mixer.

The compositions may comprise, in addition to the combination according to the invention, one or more optical brighteners, for example from the class bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative, coumarin derivative or a pyrazoline derivative.

The compositions may also comprise suspending agents for dirt, e.g. sodium carboxymethylcellulose, pH regulators, e.g. alkali metal or alkaline earth metal silicates, foam regulators, e.g. soap, salts for regulating the spray-drying and the granulating properties, e.g. sodium sulfate, perfumes and, optionally, antistatic agents and softeners, enzymes, such as amylase, bleaches, pigments and/or toning agents. Such constituents must especially be stable towards the bleach used.

In addition to the metal complexes of compounds of formula I it is also possible to use further transition metal salts or complexes known as bleach-activating active ingredients and/or conventional bleach activators, that is to say compounds that, under perhydrolysis conditions, yield unsubstituted or substituted perbenzo- and/or peroxo-carboxylic acids having from 1 to 10 carbon atoms, especially from 2 to 4 carbon atoms. Suitable bleach activators include the customary bleach activators, mentioned at the beginning, that carry O- and/or N-acyl groups having the indicated number of carbon atoms and/or unsubstituted or substituted benzoyl groups. Preference is given to polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT), compounds of formula (4): 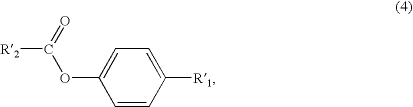
wherein R′₁ is a sulfonate group, a carboxylic acid group or a carboxylate group, and wherein R′₂ is linear or branched (C₇-C₁₅)alkyl, especially activators known under the names SNOBS, SLOBS and DOBA, acylated polyhydric alcohols, especially triacetin, ethylene glycol diacetate and 2,5-diacetoxy-2,5-dihydrofuran, and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Further preferred additives to the compositions according to the invention are polymers which, during the washing of textiles, prevent staining caused by dyes in the washing liquor that have been released from the textiles under the washing conditions. Such polymers are preferably polyvinylpyrrolidones or polyvinylpyridine-N-oxides whch may have been modified by the incorporation of anionic or cationic substituents, especially those having a molecular weight in the range of from 5000 to 60 000, more especially from 10 000 to 50 000. Such polymers are preferably used in an amount of from 0.05 to 5% by weight, especially from 0.2 to 1.7% by weight, based on the total weight of the washing composition.

The invention relates also to solid preparations, especially granules, comprising:
A) from 1 to 99% by weight, preferably from 1 to 40% by weight, e.g. from 1 to 30% by weight, of a metal complex of a compound of formula I,
B) from 1 to 99% by weight, preferably from 10 to 99% by weight, e.g. from 20 to 80% by weight, of a binder,
C) from 0 to 20% by weight, preferably from 1 to 20% by weight, of an encapsulating material,
D) from 0 to 20% by weight of a further additive and
E) from 0 to 20% by weight of water.

As binder there come into consideration anionic dispersants, non-ionic dispersants, polymers and waxes that are water-soluble or dispersible or emulsifiable in water.

The anionic dispersants used are, for example, commercially available water-soluble anionic dispersants for dyes or pigments. The following products, especially, come into consideration: condensation products of aromatic sulfonic acids and formaldehyde, condensation products of aromatic sulfonic acids with unsubstituted or chlorinated diphenylene or diphenyl oxides and optionally formaldehyde, (mono-/di-)alkylnaphthalenesulfonates, sodium salts of polymerised organic sulfonic acids, sodium salts of polymerised alkylnaphthalenesulfonic acids, sodium salts of polymerised alkylbenzenesulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsulfosuccinic acids, sodium salts of alkyl diglycol ether sulfates, sodium salts of polynaphthalenemethanesulfonates, lignosulfonates or oxylignosulfonates or heterocyclic polysulfonic acids.

Especially suitable anionic dispersants are condensation products of naphthalenesulfonic acids with formaldehyde, sodium salts of polymerised organic sulfonic acids, (mono-/di-)-alkylnaphthalenesulfonates, polyalkylated polynuclear arylsulfonates, sodium salts of polymerised alkylbenzenesulfonic acids, lignosulfonates, oxylignosulfonates and condensation products of naphthalenesulfonic acid with a polychloromethyldiphenyl.

Suitable non-ionic dispersants are especially compounds having a melting point of, preferably, at least 35° C. that are emulsifiable, dispersible or soluble in water, for example the following compounds:
1. fatty alcohols having from 8 to 22 carbon atoms, especially cetyl alcohol;
2. addition products of, preferably, from 2 to 80 mol of alkylene oxide, especially ethylene oxide, wherein some of the ethylene oxide units may have been replaced by substituted epoxides, such as styrene oxide and/or propylene oxide, with higher unsaturated or saturated monoalcohols, fatty acids, fatty amines or fatty amides having from 8 to 22 carbon atoms or with benzyl alcohols, phenyl phenols, benzyl phenols or alkyl phenols, the alkyl radicals of which have at least 4 carbon atoms;
3. alkylene oxide condensation products, especially propylene oxide condensation products (block polymers);
4. ethylene oxide/propylene oxide adducts with diamines, especially ethylenediamine;
5. reaction products of a fatty acid having from 8 to 22 carbon atoms and a primary or secondary amine having at least one hydroxy-lower alkyl or lower alkoxy-lower alkyl group, or alkylene oxide addition products of such hydroxyalkyl-group-containing reaction products;
6. sorbitan esters, preferably with long-chain ester groups, or ethoxylated sorbitan esters, such as polyoxyethylene sorbitan monolaurate having from 4 to 10 ethylene oxide units or polyoxyethylene sorbitan trioleate having from 4 to 20 ethylene oxide units;
7. addition products of propylene oxide with a tri- to hexa-hydric aliphatic alcohol having from 3 to 6 carbon atoms, e.g. glycerol or pentaerythritol;
8. fatty alcohol polyglycol mixed ethers, especially addition products of from 3 to 30 mol of ethylene oxide and from 3 to 30 mol of propylene oxide with aliphatic monoalcohols having from 8 to 22 carbon atoms.

Especially suitable non-ionic dispersants are surfactants of formula (5)
R′₁₁—O-(alkylene-O)ₙ-R′₁₂ (5)
wherein
R′₁₁ is C₈-C₂₂alkyl or C₈-C₁₈alkenyl;
R′₁₂ is hydrogen; C₁-C₄alkyl; a cycloaliphatic radical having at least 6 carbon atoms; or benzyl;
“alkylene” is an alkylene radical having from 2 to 4 carbon atoms and
n is a number from 1 to 60.

A substituent R′₁₁ or R′₁₂ in formula (5) is advantageously the hydrocarbyl radical of an unsaturated or, preferably, saturated aliphatic monoalcohol having from 8 to 22 carbon atoms. The hydrocarbyl radical may be straight-chain or branched. R′₁₁ and R′₁₂ are preferably each independently of the other an alkyl radical having from 9 to 14 carbon atoms.

Aliphatic saturated monoalcohols that come into consideration include natural alcohols, e.g. lauryl alcohol, myristyl alcohol, cetyl alcohol or stearyl alcohol, and also synthetic alcohols, e.g. 2-ethylhexanol, 1,1,3,3-tetramethylbutanol, octan-2-ol, isononyl alcohol, trimethylhexanol, trimethylnonyl alcohol, decanol, C₉-C₁₁oxo-alcohol, tridecyl alcohol, isotridecyl alcohol and linear primary alcohols (Alfols) having from 8 to 22 carbon atoms. Some examples of such Alfols are Alfol (8-10), Alfol (9-11), Alfol (10-14), Alfol (12-13) and Alfol (16-18). (“Alfol” is a registered trade mark).

Unsaturated aliphatic monoalcohols are, for example, dodecenyl alcohol, hexadecenyl alcohol and oleyl alcohol.

The alcohol radicals may be present singly or in the form of mixtures of two or more components, e.g. mixtures of alkyl and/or alkenyl groups that are derived from soybean fatty acids, palm kernel fatty acids or tallow oils.

(Alkylene-O) chains are preferably divalent radicals of the formulae

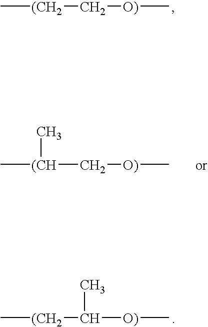

Examples of a cycloaliphatic radical are cycloheptyl, cyclooctyl and preferably cyclohexyl.

As non-ionic dispersants there come into consideration especially surfactants of formula (6) 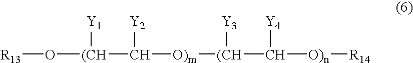
wherein
R₁₃ is C₈-C₂₂alkyl;
R₁₄ is hydrogen or C₁-C₄alkyl;
Y₁, Y₂, Y₃ and Y₄ each independently of the others are hydrogen, methyl or ethyl;
m is a number from 0 to 8; and
n is a number from 2 to 40.

Further important non-ionic dispersants correspond to formula (7) 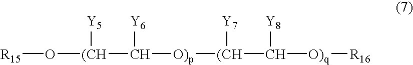
wherein
R₁₅ is C₉-C₁₄alkyl;
R₁₆ is C₁-C₄alkyl;
Y₅, Y₆, Y₇ and Y₈ each independently of the others are hydrogen, methyl or ethyl, one of the radicals Y₅, Y₆ and one of the radicals Y₇, Y₈ always being hydrogen; and p and q each independently of the other are an integer from 4 to 8.

The non-ionic dispersants of formulae (5) to (7) can be used in the form of mixtures. For example, as surfactant mixtures there come into consideration non-end-group-terminated fatty alcohol ethoxylates of formula (5), e.g. compounds of formula (5) wherein R₁₁ is C₈-C₂₂alkyl, R₁₂ is hydrogen and the alkylene-O chain is the radical —(CH₂—CH₂-O)—, and also end-group-terminated fatty alcohol ethoxylates of formula (7).

Examples of non-ionic dispersants of formulae (5), (6) and (7) include reaction products of a C₁₀-C₁₃fatty alcohol, e.g. a C₁₃oxo-alcohol, with from 3 to 10 mol of ethylene oxide, propylene oxide and/or butylene oxide or the reaction product of one mol of a C₁₃fatty alcohol with 6 mol of ethylene oxide and 1 mol of butylene oxide, it being possible for the addition products each to be end-group-terminated with C₁-C₄alkyl, preferably methyl or butyl.

Such dispersants can be used singly or in the form of mixtures of two or more dispersants.

Instead of, or in addition to, the anionic or non-ionic dispersant, the granules according to the invention may comprise a water-soluble organic polymer as binder. Such polymers may be used singly or in the form of mixtures of two or more polymers.

Water-soluble polymers that come into consideration are, for example, polyethylene glycols, copolymers of ethylene oxide with propylene oxide, gelatin, polyacrylates, polymethacrylates, polyvinylpyrrolidones, vinylpyrrolidones, vinyl acetates, polyvinylimidazoles, polyvinylpyridine-N-oxides, copolymers of vinylpyrrolidone with long-chain α-olefins, copolymers of vinyl-pyrrolidone with vinylimidazole, poly(vinylpyrrolidone/dimethylaminoethyl methacrylates), copolymers of vinylpyrrolidone/dimethylaminopropyl methacrylamides, copolymers of vinyl-pyrrolidone/dimethylaminopropyl acrylamides, quaternised copolymers of vinylpyrrolidones and dimethylaminoethyl methacrylates, terpolymers of vinylcaprolactam/vinylpyrrolidone/dimethylaminoethyl methacrylates, copolymers of vinylpyrrolidone and methacrylamido-propyl-trimethylammonium chloride, terpolymers of caprolactam/vinylpyrrolidone/dimethyl-aminoethyl methacrylates, copolymers of styrene and acrylic acid, polycarboxylic acids, polyacrylamides, carboxymethylcellulose, hydroxymethylcellulose, polyvinyl alcohols, poly-vinyl acetate, hydrolysed polyvinyl acetate, copolymers of ethyl acrylate with methacrylate and methacrylic acid, copolymers of maleic acid with unsaturated hydrocarbons, and also mixed polymerisation products of the mentioned polymers.

Of those organic polymers, special preference is given to polyethylene glycols, carboxy-methylcellulose, polyacrylamides, polyvinyl alcohols, polyvinylpyrrolidones, gelatin, hydrolysed polyvinyl acetates, copolymers of vinylpyrrolidone and vinyl acetate, and also polyacrylates, copolymers of ethyl acrylate with methacrylate and methacrylic acid, and polymethacrylates.

Suitable water-emulsifiable or water-dispersible binders also include paraffin waxes.

Encapsulating materials include especially water-soluble and water-dispersible polymers and waxes. Of those materials, preference is given to polyethylene glycols, polyamides, polyacrylamides, polyvinyl alcohols, polyvinylpyrrolidones, gelatin, hydrolysed polyvinyl acetates, copolymers of vinylpyrrolidone and vinyl acetate, and also polyacrylates, paraffins, fatty acids, copolymers of ethyl acrylate with methacrylate and methacrylic acid, and polymethacrylates.

Further additives that come into consideration are, for example, wetting agents, dust removers, water-insoluble or water-soluble dyes or pigments, and also dissolution accelerators, optical brighteners and sequestering agents.

The preparation of the granules according to the invention is carried out, for example, starting from a) a solution or suspension with a subsequent drying/shaping step or b) a suspension of the active ingredient in a melt with subsequent shaping and solidification.

In accordance with (a), first of all the anionic or non-ionic dispersant and/or the polymer and, if appropriate, the further additives are dissolved in water and stirred, if desired with heating, until a homogeneous solution is obtained. The catalyst according to the invention is then dissolved or suspended in the resulting aqueous solution. The solids content of the solution should preferably be at least 30% by weight, especially 40 to 50% by weight, based on the total weight of the solution. The viscosity of the solution is preferably less than 200 mPas.

The aqueous solution so prepared, comprising the catalyst according to the invention, is then subjected to a drying step in which all water, with the exception of a residual amount, is removed, solid particles (granules) being formed at the same time. Known methods are suitable for producing the granules from the aqueous solution. In principle, both continuous methods and discontinuous methods are suitable. Continuous methods are preferred, especially spray-drying and fluidised bed granulation processes.

Especially suitable are spray-drying processes in which the active ingredient solution is sprayed into a chamber with circulating hot air. The atomisation of the solution is effected e.g. using unitary or binary nozzles or is brought about by the spinning effect of a rapidly rotating disc. In order to increase the particle size, the spray-drying process may be combined with an additional agglomeration of the liquid particles with solid nuclei in a fluidised bed integrated into the chamber (so-called fluid spray). The fine particles (<100 μm) obtained by a conventional spray-drying process may, if necessary after being separated from the exhaust gas flow, be fed as nuclei, without further treatment, directly into the atomising cone of the atomiser of the spray-dryer for the purpose of agglomeration with the liquid droplets of the active ingredient.

During the granulation step, the water can rapidly be removed from the solutions comprising the metal complexes of compounds of formula I according to the invention, binder and further additives. It is expressly intended that agglomeration of the droplets forming in the atomising cone, or the agglomeration of droplets with solid particles, will take place.

If necessary, the granules formed in the spray-dryer are removed in a continuous process, for example by a sieving operation. The fines and the oversize particles are either recycled directly to the process (without being redissolved) or are dissolved in the liquid active ingredient formulation and subsequently granulated again.

A further preparation method according to (a) is a process in which the polymer is mixed with water and then the catalyst according to the invention is dissolved/suspended in the polymer solution, thus forming an aqueous phase, the catalyst according to the invention being homogeneously distributed in that phase. At the same time or subsequently, the aqueous phase is dispersed in a water-immiscible liquid in the presence of a dispersion stabiliser in order that a stable dispersion is formed. The water is then removed from the dispersion by distillation, forming substantially dry particles. In those particles, the catalyst is homogeneously distributed in the polymer matrix.

The granules according to the invention are resistant to abrasion, low in dust, pourable and readily meterable. They can be added directly to a formulation, such as a washing composition formulation, in the desired concentration of the catalyst according to the invention.

Where the coloured appearance of the granules in the washing composition is to be suppressed, this can be achieved, for example, by embedding the granules in a droplet of a whitish meltable substance (‘water-soluble wax’) or by adding a white pigment (e.g. TiO₂) to the granule formulation or, preferably, by encapsulating the granules in a melt consisting, for example, of a water-soluble wax, as described in EP-A-0 323 407, a white solid being added to the melt in order to reinforce the masking effect of the capsule.

In accordance with (b), the catalyst according to the invention is dried in a separate step prior to the melt-granulation and, if necessary, dry-ground in a mill so that all the solids particles are <50 μm in size. The drying is carried out in an apparatus customary for the purpose, for example in a paddle dryer, vacuum cabinet or freeze-dryer.

The finely particulate catalyst is suspended in the molten carrier material and homogenised. The desired granules are produced from the suspension in a shaping step with simultaneous solidification of the melt. The choice of a suitable melt-granulation process is made in accordance with the desired size of granules. In principle, any process which can be used to produce granules in a particle size of from 0.1 to 4 mm is suitable. Such processes are droplet processes (with solidification on a cooling belt or during free fall in cold air), melt-prilling (cooling medium gas/liquid), and flake formation with a subsequent comminution step, the granulation apparatus being operated continuously or discontinuously.

Where the coloured appearance of the granules prepared from a melt is to be suppressed in the washing composition, in addition to the catalyst it is also possible to suspend in the melt white or coloured pigments which, after solidification, impart the desired coloured appearance to the granules (e.g. titanium dioxide).

If desired, the granules can be covered or encapsulated in an encapsulating material. Methods suitable for such an encapsulation include the customary methods and also the encapsulation of the granules by a melt consisting e.g. of a water-soluble wax, as described, for example, in EP-A-0 323 407, coacervation, complex coacervation and surface polymerisation.

Encapsulating materials include e.g. water-soluble, water-dispersible or water-emulsifiable polymers and waxes.

Further additives include e.g. wetting agents, dust-removers, water-insoluble or water-soluble dyes or pigments, and also dissolution accelerators, optical brighteners and sequestering agents.

Surprisingly, the metal complexes of compounds of formula I also exhibit a markedly improved bleach-catalysing action on coloured stains on hard surfaces. The addition of such metal complexes of compounds of formula I in catalytic amounts to a dishwashing composition that comprises a peroxy compound and optionally TAED (N,N,N′,N′-tetraacetylethylenediamine) results in the substantial removal of e.g. tea stains on china. This is the case even when hard water is used, it being known that tea deposits are more difficult to remove in hard water than in soft water. The metal complexes of compounds of formula I are also very suitable for cleaning hard surfaces at low temperatures.

The use of metal complexes of compounds of formula I as catalysts for reactions with peroxy compounds in cleaning solutions for hard surfaces, especially for kitchen- and table-ware, is therefore of special interest.

The present invention relates also to cleaning compositions for hard surfaces, especially cleaning compositions for table- and kitchen-ware and, among such compositions, preferably those for use in cleaning processes carried out by machine, which compositions comprise one of the above-described metal complexes of compounds of formula I as bleach catalyst. Suitable formulations for such cleaning compositions include, for example, the formulations mentioned above for the washing compositions.

The metal complexes of compounds of formula I also have, together with peroxy compounds, excellent antibacterial action. The use of the metal complexes of compounds of formula I for killing bacteria or for protecting against bacterial attack is therefore likewise of interest.

The metal complexes of compounds of formula I are also outstandingly suitable for selective oxidation in the context of organic synthesis, especially the oxidation of organic molecules, e.g. of olefins to form epoxides. Such selective transformation reactions are required especially in process chemistry. The invention accordingly relates also to the use of the metal complexes of compounds of formula I in selective oxidation reactions in the context of organic synthesis.

The present invention relates also to a method of catalysing oxidations, wherein at least one metal complex of a compound of formula I is added to the oxidising agent.

Of special interest is a method of catalysing oxidations, wherein the oxidations relate to the bleaching of spots or stains on textile material or to the prevention of the redeposition of migrating dyes in the context of a washing process, or to the cleaning of hard surfaces.

Likewise of interest is a method of catalysing oxidations, wherein the oxidising agent is a washing, cleaning, disinfecting or bleaching composition.

The following Examples serve to illustrate the invention but do not limit the invention thereto. Parts and percentages relate to weight, unless otherwise indicated.

### EXAMPLE 1

### Preparation of an Iron Complex of Compound (101) with Iron(III) Chloride

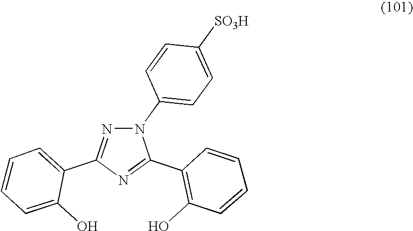

### a) Preparation of 2-(2-hydroxyphenyl)-benzo-4H-[1,3]oxazin-4-one [compound (201)]

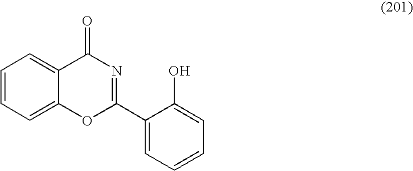

24.9 g (0.18 mol) of salicylic acid, 20.6 g (0.15 mol) of salicylamide and 1.5 ml of pyridine are heated at reflux in 30 ml of xylene. With vigorous stirring, 23.7 ml (0.33 mol) of thionyl chloride are added dropwise in the course of 4 hours. The product then begins to crystallise. The reaction mixture is stirred for a further 30 minutes and then concentrated in a vacuum rotary evaporator. Crystallisation of the residue from methoxyethanol yields 19.8 g (55%) of compound (201) in the form of fine yellow needles. ¹H NMR (DMSO-d₆): δ(ppm)=7.09 (m, 2H); 7.62 (m, 2H); 7.78 (d, 1H); 7.94 (q, 1H); 8.07 (d, 1H); 8.20 (d, 1H); 8.78 (OH).

### b) Preparation of Compound (101)

0.8 g (4.25 mmol) of 4-hydrazinobenzosulfonic acid are suspended in 100 ml of ethanol. 4.25 mmol of triethylamine and 1.0 g (4.18 mmol) of 2-(2-hydroxyphenyl)-benzo-4H-[1,3]-oxazin-4-one [compound (201), Example 1a] are added. The reaction mixture is boiled under reflux for 20 hours. After cooling to room temperature, 20 ml of 6N hydrochloric acid are added to the reaction mixture which is then concentrated using a vacuum rotary evaporator until a precipitate is formed. A further 20 ml of 6N hydrochloric acid are then added to the reaction mixture. The precipitate is filtered off, washed with a small amount of water and dried in vacuo in a drying cabinet. 1.10 g (61%) of compound (101) are obtained in the form of a bright yellow, hygroscopic powder. ¹H NMR (DMSO-d₆): δ(ppm)=6.91 (d, 1H); 6.95-7.01 (m, 2H); 7.05 (d, 1H); 7.36-7.40 (dd, 2H); 7.46 (d, 2H); 7.51 (d, 1H); 7.72 (d, 2H); 8.02 (d, 1H). C₂₀H₁₅N₃O₅S·H₂O (409.42). Analysis calculated: C, 56.02; H 4.24; N 9.61%.

Analysis found: C, 56.20; H 4.01; N 9.83%.

### c) Preparation of an Iron Complex of Compound (101) with Iron(III) Chloride

To a solution of 409 mg (1 mmol) of 4-[3,5-bis(2-hydroxyphenyl)-1,2,4-triazol)-1-yl-benzosulfonic acid monohydrate [compound (101), prepared in accordance with Example 1b] in 15 ml of methanol there is added an equimolar solution of anhydrous iron(III) chloride in methanol, the deep-violet monocomplex being formed spontaneously. The deep-violet solution is concentrated to 10 ml using a vacuum rotary evaporator and filtered. A small amount of water and isopropanol is added to the filtrate; concentration is carried out using a vacuum rotary evaporator and the residue is dried in vacuo in a drying cabinet. Analysis calculated for FeC₂₀H₁₃N₃O₅S·CH₃OH·H₂O: C, 52.12; H 3.58; N 8.29%. Analysis found: C, 52.26; H 3.49; N 8.31%.

### EXAMPLE 2

### Preparation of the Iron Complex of Compound (102) with Iron(III) Chloride

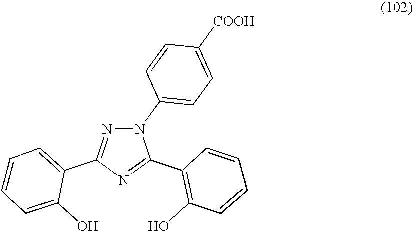

### a) Preparation of Compound (102)

1.75 g (11.50 mmol) of 4-hydrazinobenzoic acid are dissolved under reflux in 40 ml of ethanol. With continued heating, 2.50 g (10.45 mmol) of 2-(2-hydroxyphenyl)-benzo-4H-[1,3]-oxazin-4-one [compound (201), Example 1a] are added to the resulting clear solution. The reaction mixture is boiled under reflux for 3 hours, then cooled to room temperature and water is added until precipitation begins. The reaction mixture is then concentrated to half its volume using a vacuum rotary evaporator and a further 40 ml of water are added. The precipitated product is filtered off and dried in vacuo in a drying cabinet, yielding 3.28 g (80%) of compound (102), bright yellow powder, which on being left to stand in the air absorbs moisture and at the same time becomes lighter in colour. ¹H NMR (DMSO-d₆): δ(ppm)=6.90 (d, 1H); 7.00 (dt, 2H); 7.04 (d, 1H); 7.37 (dt, 2H); 7.55 (d, 1H); 7.58 (d, 2H); 8.02 (d, 2H); 8.08 (d, 1H). C₂₁H₁₅N₃O₄·1.1H₂O. Analysis calculated: C64.11; H, 4.41; N 10.69%. Analysis found: C 64.11; H, 4.60; N 10.44%.

### b) Preparation of an Iron Complex of Compound (102) with Iron(III) Chloride

To a solution of 373 mg (1 mmol) of 4-[3,5-bis(2-hydroxyphenyl)-1,2,4-triazol)-1-yl-benzoic acid monohydrate [compound (102), prepared according to Example 2a] in 15 ml of methanol there is added an equimolar solution of anhydrous iron(III) chloride in methanol, the deep-violet monocomplex being formed spontaneously. The deep-violet solution is concentrated to 10 ml using a vacuum rotary evaporator and filtered. A small amount of water and isopropanol is added to the filtrate; concentration is carried out using a vacuum rotary evaporator and the residue is dried in vacuo in a drying cabinet. Analysis calculated for FeC₂₁H₁₃N₃O₄·4H₂O: C, 50.62; H 4.05; N 8.43%. Analysis found: C, 50.46; H 4.23; N 8.54%.

### EXAMPLE 3

### Preparation of the Iron Complex of Compound (103) with iron(III) Chloride

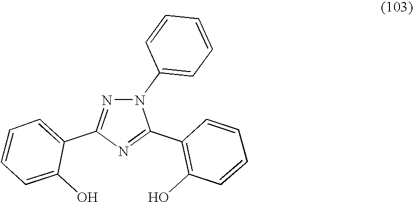

### a) Preparation of Compound (103)

A solution of 1.45 g (10.3 mmol) of phenylhydrazine hydrochloride in 80 ml of ethanol is heated briefly at reflux. After cooling to room temperature, 2.0 g (8.36 mmol) of 2-(2-hydroxyphenyl)-benzo-4H-[1,3]-oxazin-4-one [compound (201), Example 1a] are added. The reaction mixture is then boiled under reflux for a further 2 hours. The clear, colourless reaction solution is cooled to room temperature; 40 ml of 1 N hydrochloric acid are added and the precipitated solid is filtered off and dried overnight in vacuo in a drying cabinet. Crystallisation of the residue from methanol yields 1.72 g (63%) of compound (103). ¹H NMR (DMSO-d₆): δ(ppm)=6.89 (d, 1H); 6.94 (t, 1H); 7.01 (t, 1H); 7.03 (d, 1H); 7.37 (t, 2H); 7.42-7.48 (m, 6H); 7.85 (d, 1H); 9.88 (s, OH); 10.71 (s, OH). C₂₀H₁₅N₃O₂ (329.36). Analysis calculated: N 12.76%. Analysis found: 12.67%.

### b) Preparation of the Iron Complex of Compound (103) with Iron(III) Chloride

To a solution of 329 mg (1 mmol) of compound (103), prepared according to Example 3a, in 15 ml of ethanol there is added an equimolar solution of anhydrous iron(III) chloride in ethanol, the deep-violet monocomplex being formed spontaneously. The deep-violet solution is concentrated to 10 ml using a vacuum rotary evaporator and filtered. A small amount of water and isopropanol is added to the filtrate; concentration is carried out using a vacuum rotary evaporator and the residue is dried in vacuo in a drying cabinet. Analysis calculated for FeC₂₀H₁₃N₃O₂Cl·C₂H₅OH·H₂O: C, 48.54; H 4.55; N 9.99%. Analysis found: C, 48.07; H 4.57; N 9.83%.

### EXAMPLE 4

### Preparation of an Iron Complex of Compound (103) with Iron(III) Chloride

Saturated sodium ethanolate solution is added, with stirring, to a solution of 186 mg (1 mmol) of anhydrous iron(III) chloride and 660 mg (2 mmol) of compound (103), prepared according to Example 3a, in 20 ml ethanol until a precipitate begins to form. The reaction mixture is left to stand at 0° C. for 24 hours. The reddish-violet precipitate is filtered off and dried in vacuo in a drying cabinet for 24 hours. Dark-red crystals are obtained. Na[Fe(C₂₀H₁₃N₃O₂)₂]·C₂H₅OH·2H₂O. Analysis calculated: C, 61.85; H 4.45; N 10.30%. Analysis found: C, 62.49; H 4.15; N 10.0%.

### EXAMPLE 5

### Preparation of an Iron Complex of Compound (102) with Iron(III) Chloride

A solution of 186 mg (1 mmol) of anhydrous iron(III) chloride and 740 mg (2 mmol) of compound (102), prepared according to Example 2a, in 20 ml methanol is deprotonated with 0.1 M potassium hydroxide solution until the colour of the solution changes from violet to red. The resulting solution is concentrated using a rotary evaporator and cooled to 8° C. After two days a red precipitate is formed, which is filtered off and dried in vacuo in a drying cabinet. A red powder is obtained. K₃[Fe(C₂₁H₁₃N₃O₄)₂]·2 CH₃OH·2H₂O. Analysis calculated: C, 52.12; H 3.58; N 8.29%. Analysis found: C, 52.26; H 3.49; N 8.31%.

### EXAMPLE 6

### Preparation of a Manganese Complex of Compound (103) with Manganese(III) Acetate Dihydrate

660 mg (2 mmol) of compound (103), prepared according to Example 3a, in 20 ml of methanol are added to a solution of 268 mg (1 mmol) of manganese(III) acetate dihydrate in 10 ml of methanol, a greenish-black precipitate being formed spontaneously. The dark-brown solution is concentrated to 10 ml in a vacuum rotary evaporator and then filtered. A small amount of water and isopropanol is added to the filtrate; concentration is carried out using a vacuum rotary evaporator and the residue is dried in vacuo in a drying cabinet. A brownish-black powder is obtained. ESI-MS [m/z] 709 [ML₂]; 710 [ML₂+H]⁺; 732 [ML₂+Na]⁺; 329 (ligand).

### EXAMPLE 7

### Preparation of a Manganese Complex of Compound (102) with Manganese(III) Acetate Dihydrate

To a solution of 427 mg (1 mmol) of compound (102), prepared according to Example 2a, in 15 ml of methanol there is added an equimolar solution of manganese(III) acetate dihydrate in methanol, a brownish-black precipitate being formed spontaneously. The dark-brown solution is concentrated to 10 ml using a vacuum rotary evaporator and then filtered. A small amount of water and isopropanol is added to the filtrate; concentration is carried out using a vacuum rotary evaporator, followed by drying in vacuo in a drying cabinet. A brownish-black powder is obtained. ESI-MS [m/z] 797 [ML₂+H]⁺, 373 (ligand).

### EXAMPLE 8

### Preparation of Compound (104)

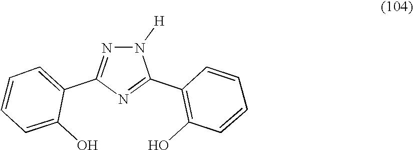

2.39 g (10 mmol) of 2-(2-hydroxyphenyl)-benzo-4H-[1,3]-oxazin-4-one [compound (201), Example 1a] are added, with intensive stirring, to a solution of 500 mg (10 mmol) of hydrazine hydrate in 50 ml of ethanol. The reaction mixture is boiled under reflux, then cooled and concentrated to half using a vacuum rotary evaporator. 20 ml of 6N hydrochloric acid are then added, with stirring, to the resulting reaction solution, which is then left to stand in a refrigerator for 24 hours. The precipitated product is filtered off and dried in vacuo in a drying cabinet. 1.77 g (70%) of compound (104) are obtained in the form of a colourless powder. C₁₄H₁₁N₃O₂ (253.26). Analysis calculated: C, 66.40; H 4.38; N 16.59%. Analysis found: C, 66.08; H 4.50; N 16.33%.

### EXAMPLE 9

### Preparation of Compound (105)

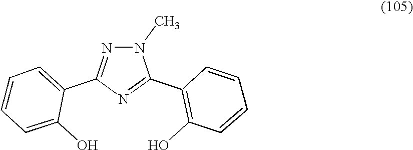

Analogously to Example 8, using 460 mg (10 mmol) of methylhydrazine and 2.39 g (10 mmol) of 2-(2-hydroxyphenyl)-benzo-4H-[1,3]-oxazin-4-one [compound (201), Example 1a] there are obtained 1.87 g (70%) of compound (105) in the form of a colourless powder. C₁₅H₁₃N₃O₂ (267.29). Analysis calculated: C, 67.41; H 4.90; N 15.72%. Analysis found: C, 67.80; H 4.58; N 15.40%.

### EXAMPLE 10

### Preparation of Compound (106)

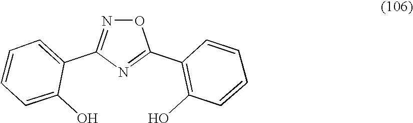

100 mg (0.418 mmol) of 2-(2-hydroxyphenyl)-benzo-4H-[1,3]-oxazin-4-one [compound (201), Example 1a] and 58.1 mg (0.836 mmol) of hydroxylamine hydrochloride are reacted in accordance with Y. I. Ryabukhin, L. N. Faleeva, V. G. Korobkova, Khim. Geterotsikl. Soedin 3 (1983) 406-410. The reaction is monitored by thin-layer chromatography (n-hexane/ethyl acetate 1:1). 47 mg (44%) of compound (106), colourless, light-beige crystals, are obtained. M.p. 171° C. [Lit. 167-168° C.]. ¹H NMR (DMSO-d₆) δ(ppm)=7.0-7.2 (m, 4H, aryl-H); 7.45 and 7.60 (m, each 2H, aryl-H).

### EXAMPLE 11

### Preparation of Compound (107)

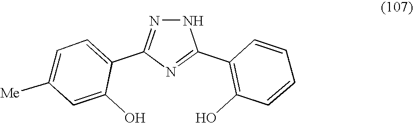

### a) 2-(2-Hydroxyphenyl)-7-methoxybenzo-[1,3]oxazin-4-one [compound (202)]

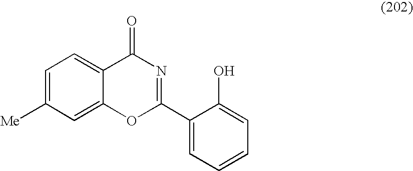

15.1 g (0.09 mol) of 2-hydroxy-4-methoxy-benzoic acid, 10.3 g (0.075 mol) of salicylamide and 0.75 ml of pyridine are heated at reflux in 20 ml of xylene. 12 ml (0.165 mol) of thionyl chloride are added dropwise to the resulting clear solution in the course of 2.5 hours with vigorous stirring. The solution is maintained at reflux for 30 minutes, then cooled to room temperature and stirred for 10 hours to complete the reaction. The reaction solution is evaporated to dryness in vacuo. Crystallisation of the yellow crude product with phenoxyethanol yields the desired product.

Yield: 3.34 g (17%), bright-yellow solid.

¹H NMR (DMSO-d₆) δ=3.87 (s, 3H), 6.63 (s, 1H), 6.7 (d, 1H), 7.59 (t, 1H), 7.73 (d, 1H), 7.92 (t, 1H), 8.04 (d, 1H), 8.1 (d, 1H), 13.25 (s, 1H, OH).

### b) Preparation of Compound (107)

1 g (3.71 mmol) of 2-(2-hydroxyphenyl)-7-methoxybenzo[1,3]oxazin-4-one [compound (202), Example 11a] is added to a solution of 186 mg (3.71 mmol) of hydrazine hydrate in 20 ml of ethanol. The bright-yellow suspension is heated at reflux for 2 hours. After cooling to room temperature, the reaction mixture is concentrated to half its volume. The product then begins to crystallise. The crystals are filtered off, washed with a small amount of cold ethanol and dried in vacuo at 30° C.

Yield: 985 mg (94%), colourless crystals,

¹H NMR (DMSO-d₆): 3.35 (s, br, NH), 3.77 (s, 3H, OCH₃), 6.6 (m, 2H), 6.95 (s, 1H), 7.00 (t, 1H), 7.35 (t, 1H), 8.0 and 8.92 (each d, 1H); 11.0-12.0 (s, br, OH).

### EXAMPLE 12

### Preparation of Compound (108)

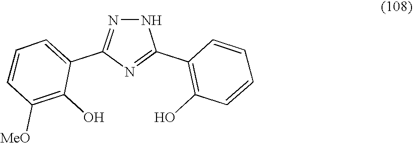

### a) Preparation of 2-(2-hydroxyphenyl)-8-methoxy-benzo[1,3]oxazin-4-one [Compound (203)]

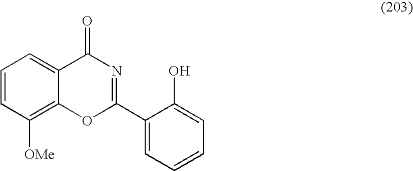

A reaction solution of 15.1 g (0.09 mol) of 2-hydroxy-3-methoxybenzoic acid, 10.28 g (0.075 mol) of salicylamide and 750 μl (0.0093 mol) of pyridine in 60 ml of xylene is heated at reflux. Under reflux, 11.85 ml (0.164 mol) of thionyl chloride are added dropwise in the course of 4 hours. The solution is allowed to cool to room temperature. The solution is concentrated to half in vacuo and left to stand at 15° C. for 8 hours. The precipitate formed is filtered off, washed with a small amount of ethanol and recrystallised from methoxyethanol with the addition of activated carbon. The end product is filtered and dried under a high vacuum at 35° C. Yield: 4.8 g (20%), yellowish solid.

### b) Preparation of Compound (108)

A solution of 108 μl (2.23 mmol) of hydrazine monohydrate in 12 ml of ethanol is reacted with 600 mg (2.23 mmol) of 2-(2-hydroxyphenyl)-8-methoxy-benzo[1,3]oxazin-4-one [compound (203), Example 12a] and worked up as described in Example 11 b). 528 mg (84%) of colourless crystals are obtained.

¹H NMR (DMSO-d₆) δ=3.35 (s, br, NH); 3.83 (s, 3H, OCH₃); 6.9-7.1 (m, 4H); 6.95 (s, 1H); 7.35 (t, 1H); 7.60 (d, 1H); 8.02 (d, 1H); 11.0-12.0 (s, br, OH).

### EXAMPLE 13

### Preparation of Compound (109)

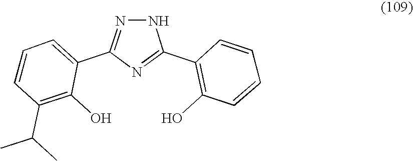

### a) Preparation of 2-(2-hydroxyphenyl)-8-isopropyl-benzo-[1,3]oxazin-4-one [Compound 204]

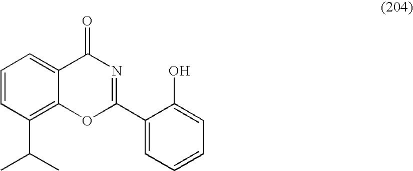

4.9 g (0.07 mol) of 2-hydroxy-3-isopropylbenzoic acid, 3.1 g (0.0225 mol) of salicylamide and 225 μl (0.0028 mol) of pyridine are heated at reflux in 20 ml of xylene. 3.6 ml (0.05 mol) of thionyl chloride are added dropwise to the resulting clear solution in the course of 4 hours with vigorous stirring. The solution is maintained at reflux for 30 minutes, then cooled to room temperature and stirred for 8 hours to complete the reaction. The reaction solution is concentrated to half in vacuo and left to stand for one day at 8° C. A yellowish-green crystal slurry separates out. The crude product is filtered off and washed with a small amount of cold ethanol. Purification is carried out by recrystallisation from methoxyethanol. Isolation is carried out by filtration and subsequent drying at 35° C. under a high vacuum.

Yield: 2.3 g (31%), yellowish crystals.

¹H NMR (CDCl₃) δ=1.3 (d, 6H); 7.50 (m, 4H), 7.82 (t, 1H); 7.96 (d, 1H), 8.22 (d, 1H).

### b) Preparation of Compound (109)

626 mg (2.23 mmol) of 2-(2-hydroxyphenyl)-8-isopropyl-benzo-[1,3]oxazin-4-one [compound (204), Example 13a] are slowly introduced into a solution of 108.2 μl (2.23 mmol) of hydrazine monohydrate in 12 ml ethanol and the mixture is heated at reflux for 2.5 hours. After cooling to room temperature, the solution is concentrated to half in vacuo. 7 ml (4 mol/l) of hydrochloric acid are added dropwise, with stirring. The suspension is cooled at 8° C. for 24 hours, then diluted with 2 ml of cold ethanol. The precipitate is filtered off, washed with a small amount of cold ethanol and dried under a high vacuum at 35° C.

Yield: 0.7 g (90%).

¹³C NMR (DMSO-d₆) δ=22.7 (CH₃), 26.7 (CH), 113.4 (quat. C), 116.9; 119.6; 120.0; 124.4; 128.0; 128.8 (tert. CH), 136.1 (quat. C), 153.9 and 156.1 (quat. C).

The compound is isolated in the form of the hydrochloride with one molecule of water.

C₁₇H₁₇N₃O₂·H₂O·HCl (349.79) Analysis calculated: C, 58.37; H 5.76; N 12.01%. Analysis found: C, 58.70; H 6.09; N 11.91%.

### EXAMPLE 14

### Preparation of Compound (110)

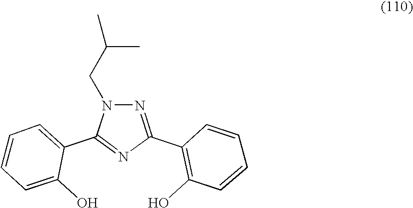

500 mg (2.09 mmol) of 2-(2-hydroxyphenyl)-benzo-4H-[1,3]-oxazin-4-one [compound (201), Example 1a] are added, with stirring, at room temperature to a solution of 261 mg (2.09 mmol) of tert-butyl hydrazine hydrochloride in 11 ml of ethanol. The resulting suspension is heated at reflux for 3 hours, a clear solution being formed. The solution is concentrated to half, and 5 ml of 6N hydrochloric acid are added. The precipitate that forms is filtered off, washed with a small amount of cold ethanol and dried at room temperature in a vacuum drying cabinet.

Yield: 192 mg (29%) of colourless crystals.

¹H NMR (DMSO-d₆) δ=1.5 (s, 6H), 2.55 (s, 2H), 4.40 (m, 1H), 7.05 (m, 4H), 7.05 (m, 6H), 7.52 (m, 2H), 10.4 (s, br, 1H, OH), 11.4 (s, br, 1H).

### EXAMPLE 15

### Preparation of Compound (111)

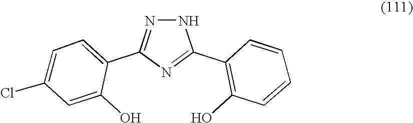

### a) Preparation of 2-(2-hydroxyphenyl)-7-chloro-benzo[1,3]oxazin-4-one [compound (205)]

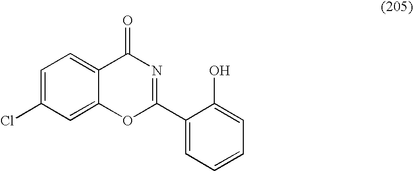

225 μl (2.8 mmol) of pyridine are added dropwise to a reaction mixture of 4.65 g (0.027 mol) of 4-chlorosalicylic acid and 3.1 g (0.0225 mol) of salicylamide. The mixture is heated at reflux, a clear solution being formed. 3.55 ml (0.050 mol) of thionyl chloride are added dropwise in the course of 3 hours at reflux. The solution is cooled to room temperature. 10 ml of xylene are added and stirring is carried out at room temperature for 2 hours to complete the reaction. The reaction solution is evaporated to dryness and suspended with 20 ml of ethanol and 225 ml of glacial acetic acid. The precipitate is filtered off and washed with a small amount of ethanol. The crude product is recrystallised from 2-methoxyethanol with the addition of activated carbon.

Yield: 2.8 g (38%).

¹H NMR (CDCl₃): δ=6.90 (m, 1H), 7.00 (m, 1H), 7.42 (m, 2H), 7.74 and 7.94 (m, each 1H).

### b) Preparation of Compound (111)

600 mg (2.18 mmol) of 2-(2-hydroxyphenyl)-7-chloro-benzo-[1,3]oxazin-4-one [compound (205) of Example 15 a] are introduced into a solution of 108 μl (2.18 mmol) of hydrazine monohydrate in 12 ml of ethanol. The reaction solution is heated at reflux for 4 hours. After cooling to room temperature, the precipitate is filtered off, washed with cold ethanol and dried at 35° C. under a high vacuum.

Yield: 601 mg (95%), colourless crystals,

¹H NMR (CDCl₃): δ=3.3-3.6 (br, 1H, NH), 7.05 (m, 4H), 7.38 (m, 1H), 8.06 (m, 2H), 11.5-13.0 (s, br, 2H, OH).

### EXAMPLE 16

### Preparation of Compound (112)

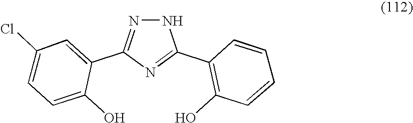

### a) 2-(2-Hydroxyphenyl)-6-chloro-benzo[1,3]oxazin-4-one [compound (206)]

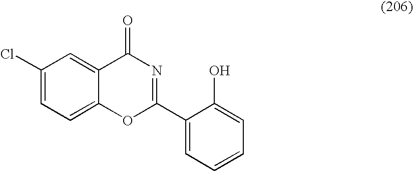

A reaction solution of 4.65 g (0.027 mol) of 5-chlorosalicylic acid and 3.1 g (0.0225 mol) of salicylamide is reacted with 225 μl (0.028 mol) of pyridine and 3.55 ml (0.050 mol) of thionyl chloride, worked up and recrystallised as described in Example 15 a).

Yield: 2.3 g (32%), colourless solid.

¹H NMR. (CDCl₃): δ=6.97 (m, 1H), 7.43 (m, 2H); 7.7; 8.0 and 8.1 (m, 1H).

### b) Preparation of Compound (112)

A reaction solution of 108 μl (2.18 mmol) of hydrazine monohydrate, 600 mg (2.18 mmol) of 2-(2-hydroxyphenyl)-6-chloro-benzo[1,3]oxazin-4-one [compound (206) of Example 16 a] is reacted and worked up as described in Example 15 b). Yield: 541 mg (86%), colourless solid.

¹H NMR (DMSO-d₆): δ=3.33 (br, 1H, NH), 7.04 (m, 3H), 7.37 (m, 2H), 8.02 (m, 2H), 10.6-12.0 (s, br, 2H, OH).

### EXAMPLE 17A

### Prevention of the Deposition of Dyes on Cotton During the Washing Process

For testing the activity of the catalysts, the DTI activity is determined. The DTI (Dye Transfer Inhibition) activity a is defined as the following percentage.
a=([Y(E)−Y(A)]/[Y(W)−Y(A)])*100
where Y(W), Y(A) and Y(E) are the CIE lightness values of the white material, of the material treated without the addition of catalyst and of the material treated with the addition of catalyst, in that order. a=0 denotes a completely useless product, the addition of which to the washing liquor allows dye transfer to take place freely, whereas a=100% corresponds to a perfect catalyst which totally prevents the staining of the white material.

The following test system is used to obtain the test data: 7.5 g of white cotton fabric are treated in 80 ml of washing liquor. The liquor contains the standard washing composition ECE phosphate-free (456 IEC) EMPA, Switzerland, in a concentration of 7.5 g/l, 8.6 mmol/l H₂O₂ and a solution of the test dye. The washing operation is carried out in a beaker in a LINITEST apparatus for 30 minutes at 40° C. The catalysts are used in the standard manner in the concentrations indicated. As a representative commercial dye, the dye F4 (Reactive Blue 238) is used. The reflection spectra of the samples are measured using a Spectraflash 200 and converted into lightness values (D65/10) in accordance with a standard CIE procedure. The manganese complexes according to the invention are prepared from the corresponding ligands in situ immediately before the screening, a solution of 10 mmol of manganese(II) chloride in water being added to a solution of 10 mmol of ligand in methanol/water.

Table 1 below shows the results obtained with the manganese complexes obtained in accordance with an in situ process. Table 1 gives DTI effects a as a function of catalyst concentration, under use conditions as described above. The activity is measured at catalyst concentrations of 5 μM, 20 μM and 50 μM. In addition, measurements are made at a concentration of 20 μM in the presence of Dequest® 2041 [ethylenediaminetetramethylenephosphoric acid of formula P1].

TABLE 1

| | |
|---|---|
| | (P1) |
| 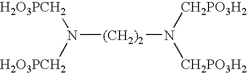 | |

| | Manganese | | | | |
|---|---|---|---|---|---|
| | complex of | | a(%) | a(%) | a (%) + |
| Ex- | ligand from | a (%) | 20 μM | 50 μM | Dequest |
| amples | Example No. | 5 μM (F4) | (F4) | (F4) | 20 μM (F4) |
| 17a | 1b | 85 | 97 | 97 | 96 |
| 17b | 2a | 73 | 89 | 97 | 98 |
| 17c | 8 | 82 | 97 | 92 | 95 |
| 17d | 11 | | | 67 | |
| 17e | 12 | | | 82 | |
| 17f | 13 | | | 84 | |
| 17g | 14 | | | 60 | |

The results in Table 1 show that the manganese complexes, obtained in accordance with an in situ process and starting from the ligands according to Examples 1b, 2a, 8, 11, 12, 13 and 14, are very effective in preventing the redeposition of the dye on cotton.

### EXAMPLE 18

### Prevention of the Deposition of Dyes on Cotton During the Washing Process

The following test system is used to obtain the test data:

7.5 g of white cotton fabric are treated in 80 ml of washing liquor (liquor ratio 1:10). The liquor contains the liquid detergent in a concentration of 4.0 g/l, 8.6 mmol/l H₂O₂ and a solution of the test dye. Two liquid detergents are used with the following composition:

| component | Det. A | Det. B |
|---|---|---|
| Marlon A375 | 14 | 14 |
| Edenor K12-18 | 12 | 3 |
| Neodol 45-7E | 20 | 11 |
| Triethanolamine | 5 | 2 |
| Ethanolamine | 5 | 4 |
| Isopropanol | 1 | 4 |
| Propylene glycol | 11 | 4 |
| Citric acid 50% | 2 | 4 |
| Water | 30 | 54 |
| pH | 9.4 | 9.8 |

The washing operation is carried out in a beaker in a LINITEST apparatus for 30 minutes at 40° C. The catalyst is used in the standard manner in the concentrations indicated. As a representative commercial dye, the dye F4 (Reactive Blue 238) is used. The reflection spectra of the samples are measured using a Spectraflash 200 and converted into lightness values (D65/10) in accordance with a standard CIE procedure. The manganese complexes are prepared following the in situ procedure described in Example 17 with methanol as solvent.

Table 2 below shows the results obtained with the manganese complex of the ligand described in Example 8.

Table 2 gives DTI effects a as a function of catalyst concentration, under use conditions as described above. The activity is measured at catalyst concentrations of 20 mM and 50 mM with liquid detergents A and B.

TABLE 2

| | Manganese | | | |
|---|---|---|---|---|
| | complex of | | | |
| | ligand from | a (%) | a (%) | |
| Examples | Example No. | 20 mM (F4) | 50 mM (F4) | Detergent |
| 18a | 8 | 65 | 77 | Det. A |
| 18b | 8 | 68 | 79 | Det. B |

The results in Table 2 show that the manganese complexes, obtained in accordance with an in situ process and starting from the ligands according to Example 8 are very effective in preventing the redeposition of the dye on cotton.

### EXAMPLE 19

### Bleaching of Tea Stains on Cotton Fabric

The bleaching action of the manganese complex of the ligand 4-(3,5-bis(2-hydroxyphenyl)-1,2,4-triazol)-1-yl-benzosulfonic acid monohydrate of Example 1b, which is prepared in situ with manganese(III) acetate, is tested under the following conditions: a cloth (4 cm×9 cm) made of cotton fabric stained with commercially available tea (BC-01, CFT) is treated in a bleaching liquor. The liquor contains 100 ml of water (2.2 ° dH), 0.4577 g of sodium percarbonate and the catalyst or activator in the concentration given in Table 3. The washing operation is carried out in a steel beaker in a LINITEST apparatus for 10 minutes at 30° C. For evaluating the bleaching results, the increase in lightness, DY (difference in lightness according to CIE), of the stains brought about by the treatment is used. The results are summarised in Table 3.

TABLE 3

| | Manganese | |
|---|---|---|
| | complex of ligand | |
| Examples | of Example No. 1b | DY |
| 19a^{a)} | — | 7.8 |
| 19b^{a)} | 200 mg TAED | 9.6 |
| 19c^{b)} | 5 mg | 10.9 |
| 19d^{b)} | 25 mg | 13.9 |

^{a)}Comparison Example
^{b)}Example according to the invention

The results show that the catalyst according to the invention (in situ manganese complex of the ligand of Example 1b) significantly increases the bleaching action of sodium percarbonate under these conditions. Under these conditions, a significantly better bleaching action is obtained with this catalyst than with the conventional bleach activator TAED [tetraacetylethylenediamine] of formula B1 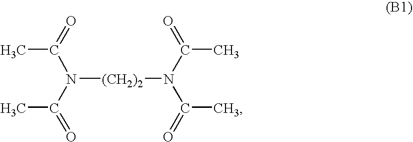
even when the latter is present in a substantially higher concentration.

1. A method of catalysing an oxidation reaction, which comprises adding to a reaction mixture comprising an oxidizable substrate an oxidising agent and at least one metal complex of a compound of the formula I 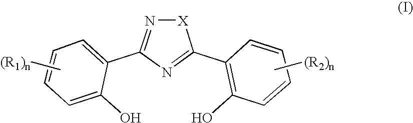
wherein
X is oxygen or 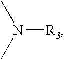
R₁ and R₂ each independently of the other are halogen, hydroxy, cyano, nitro, 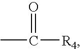
—SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 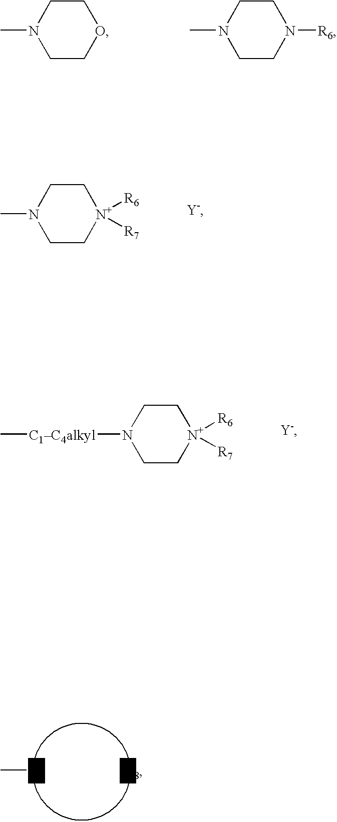
di(C₁-C₄acyl)amino, C₁-C₈alkyl, C₀-C₈alkoxy or C₁-C₈alkanoyl,
R₃ is hydrogen, C₁-C₁₂alkyl, phenyl or 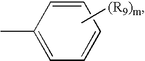
R₄ is —OR₁₀, —NH₂, —NHR₁₁, 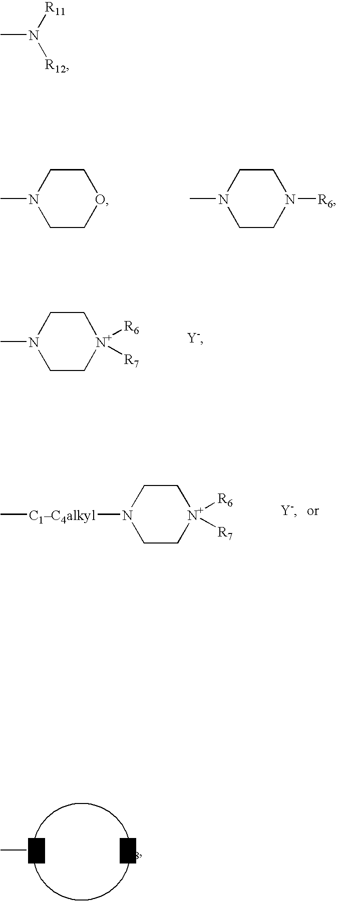
R₅ is —OR₁₀, C₁-C₈alkyl or —NH₂,
R₆ is hydrogen, C₁-C₈alkyl or C₇-C₉phenylalkyl,
R₇ is hydrogen, C₁-C₈alkyl or C₇-C₉phenylalkyl,
R₈ is unsubstituted or C₁-C₄alkyl-substituted C₂-C₁₂alkylene,
R₉ is halogen, hydroxy, cyano, nitro, 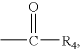
—SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 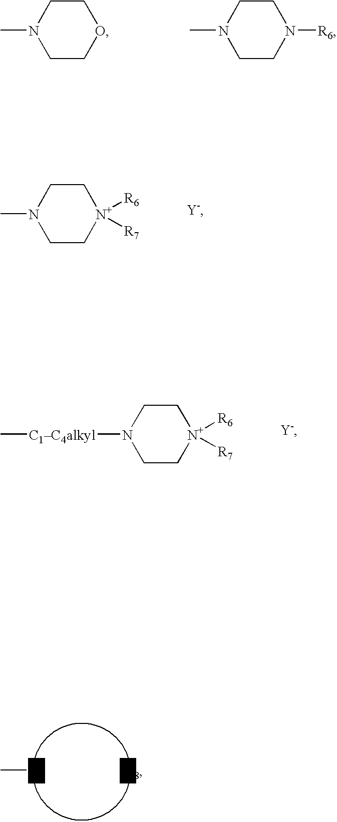
di(C₁-C₄acyl)amino, C₁-C₈alkyl, C₁-C₈alkoxy or C₁-C₈alkanoyl,
R₁₀ is hydrogen, sodium or potassium,
R₁₁ and R₁₂ each independently of the other are C₁-C₈alkyl,
Y⁻ is a monovalent anion,
m is 1 or 2, and
n is 0, 1, 2 or 3.

2. A method according to claim 1, wherein the metal is iron, manganese, titanium, cobalt, nickel or copper.

3. A method according to claim 1, wherein
X is oxygen or 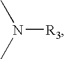
R₁ and R₂ each independently of the other are chlorine, bromine, hydroxy, cyano, nitro, 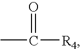
—SO₂R₅, trifluoromethyl, trifluoromethoxy; chloromethyl, trichloromethyl, trichloromethoxy, benzyloxy, amino, C₁-C₄alkylamino, C₁-C₄acylamino, di(C₁-C₄alkyl)amino, 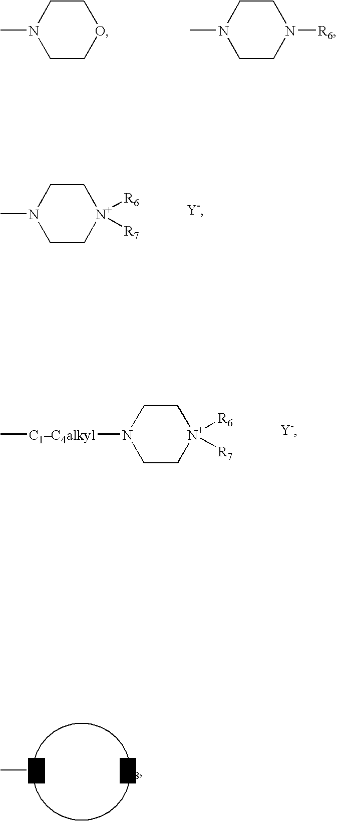
di(C₁-C₄acyl)amino, C₁-C₄alkyl, C₁-C₄alkoxy or C₂-C₄alkanoyl,
R₃ is hydrogen, C₁-C₈alkyl, phenyl or 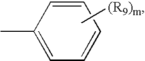
R₄ is —OR₁₀, —NH₂, —NHR₁₁, 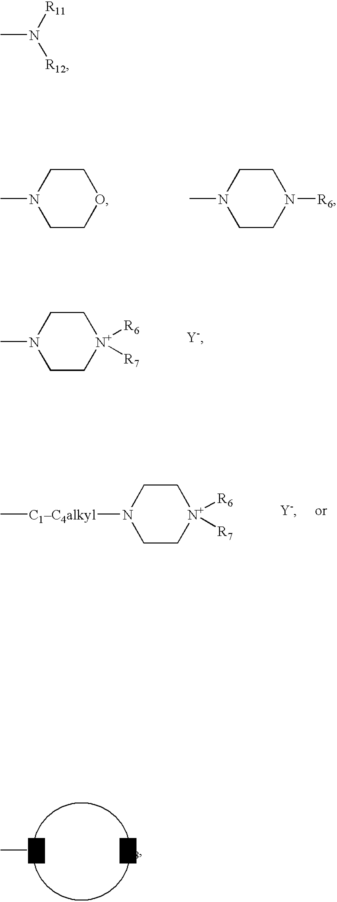
R₅ is —OR₁₀, C₁-C₄alkyl or —NH₂,
R₆ is hydrogen, C₁-C₄alkyl or benzyl,
R₇ is hydrogen, C₁-C₄alkyl or benzyl,
R₈ is C₂-C₈alkylene,
R₉ is fluorine, chlorine, bromine, hydroxy, cyano, nitro, 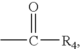
—SO₂R₅, trifluoromethyl; trifluoromethoxy; chloromethyl, trichloromethyl, chloromethoxy, benzyloxy, amino, C₁-C₄alkylamino, C₁-C₄acylamino, di(C₁-C₄alkyl)amino, 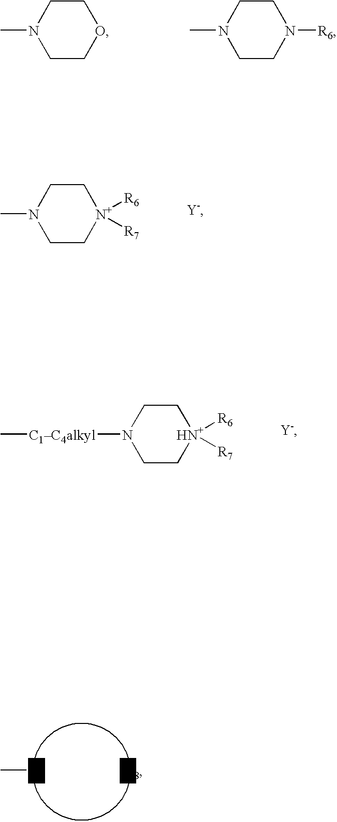
di(C₁-C₄acyl)amino, C₁-C₄alkyl, C₁-C₄alkoxy or C₂-C₄alkanoyl,
R₁₀ is hydrogen, sodium or potassium,
R₁₁, and R₁₂ each independently of the other are C₀-C₄alkyl,
Y⁻ is halide, nitrate or carboxylate,
m is 1 or 2, and
n is 0, 1 or 2.

4. A method according to claim 1, wherein
X is oxygen or 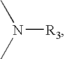
R¹ and R₂ each independently of the other are chlorine, hydroxy, cyano, 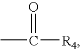
—SO₂R₅, C₁-C₄acylamino, di(C₁-C₄alkyl)amino, 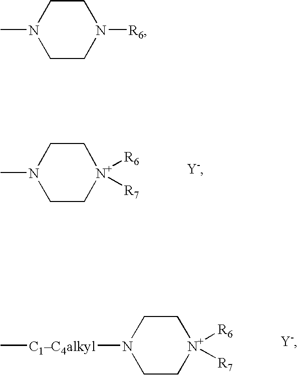
di(C₁-C₄acyl)amino, C₁-C₄alkyl, methoxy, chloromethyl or C₂-C₄alkanoyl,
R₃ is hydrogen, C₁-C₈alkyl, phenyl or 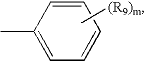
R₄ is —OR₁₀, —NH₂, —NHR₁₁ or 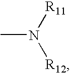
R₅ is —OR₁₀, methyl or —NH₂,
R₆ and R₇ each independently of the other are hydrogen, C₁-C₄alkyl or benzyl,
R₉ is chlorine, hydroxy, cyano, nitro, 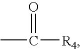
—SO₂R₅ or methoxy,
R₁₀ is hydrogen, sodium or potassium,
R₁₁ and R₁₂ each independently of the other are C₁-C₄alkyl,
Y⁻ is chloride or carboxylate,
m is 1, and
n is 0 or 1.

5. A method according to claim 1, wherein the metal is iron or manganese,
X is oxygen or 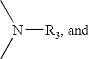
R₃ is hydrogen, C₁-C₄alkyl, phenyl or 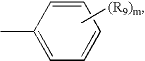
R₄ and R₅ are —OR₁₀,
R₉ is 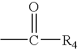
or —SO₂R₅,
R₁₀ is hydrogen,
m is 1, and
n is 0.

6. A method according to claim 1, wherein a metal complex of a compound of formula I is used in a washing, cleaning, disinfecting or bleaching composition.

7. A method according to claim 1, wherein a metal complex of a compound of formula I is formed from a compound of formula I according to claim 1 and a metal salt in situ in a washing, cleaning, disinfecting or bleaching composition.

8. A method according to claim 1, wherein a metal complex of a compound of formula I is used together with a peroxy compound for the bleaching of spots or stains on textile material or for the prevention of redeposition of migrating dyes in the context of a washing process, or for the cleaning of hard surfaces.

9. A method according to claim 1, wherein a metal complex of a compound of formula I is used as catalyst for reactions with peroxy compounds for bleaching in a paper-making process.

10. A method according to claim 1, wherein a metal complex of a compound of formula I is used as catalyst for selective oxidations in an organic synthesis.

11. A metal complex of a compound of formula I 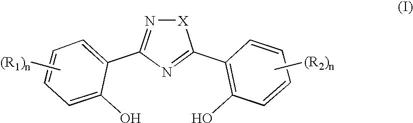
wherein
X is oxygen or 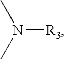
R₁ and R₂ each independently of the other are halogen, hydroxy, cyano, nitro, 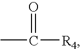
—SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 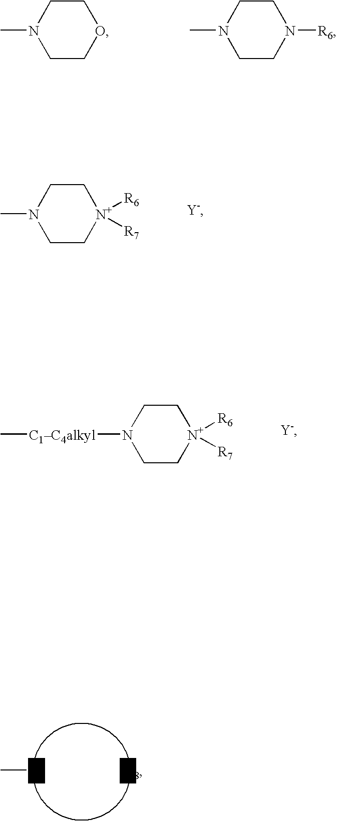
di(C₁-C₄acyl)amino, C₁-C₈alkyl, C₁-C₈alkoxy or C₁-C₈alkanoyl,
R₃ is hydrogen, C₁-C₁₂alkyl, phenyl or 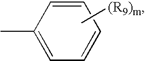
R₄ is —OR₁₀, —NH₂, —NHR₁₁, 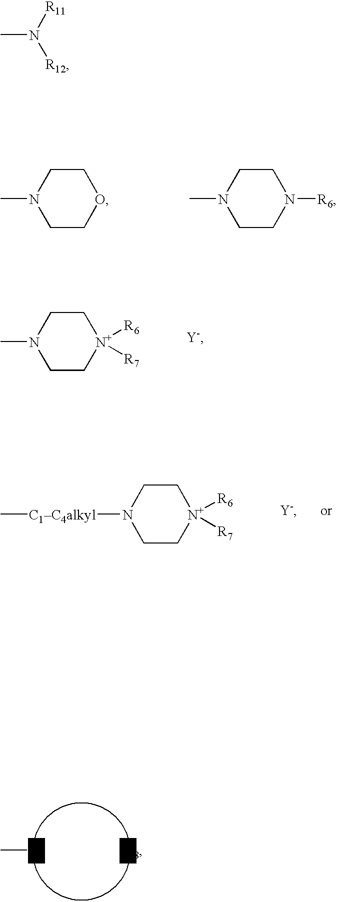
R₅ is —OR₁₀, C₁-C₈alkyl or —NH₂,
R₆ is hydrogen, C₁-C₈alkyl or C₇-C₉phenylalkyl,
R₇ is hydrogen, C₁-C₈alkyl or C₇-C₉phenylalkyl,
R₈ is unsubstituted or C₁-C₄alkyl-substituted C₂-C₁₂alkylene,
R₉ is halogen, hydroxy, cyano, nitro, 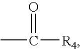
—SO₂R₅, fluoro-substituted C₁-C₈alkyl; fluoro-substituted C₁-C₈alkoxy; chloro-substituted C₁-C₈alkyl; chloro-substituted C₁-C₈alkoxy; C₇-C₉phenylalkoxy, amino, C₁-C₈alkylamino, C₁-C₈acylamino, di(C₁-C₄alkyl)amino, 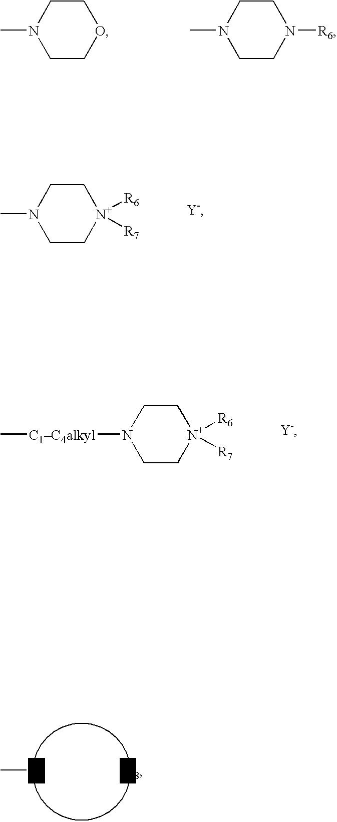
di(C₁-C₄acyl)amino, C₁-C₈alkyl, C₁-C₈alkoxy or C₁-C₈alkanoyl,
R₁₀ is hydrogen, sodium or potassium,
R₁₁ and R₁₂ each independently of the other are C₁-C₈alkyl,
Y⁻ is a monovalent anion,
m is 1 or 2, and
n is 0, 1, 2 or 3.

12. A metal complex of a compound of formula I as described in claim 1 wherein
the metal is iron or manganese,
X is oxygen or 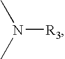
and
R₃ is hydrogen, C₁-C₄alkyl, phenyl or 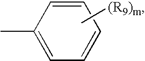
R₄ and R₅ are —OR₁₀,
R₉ is 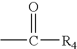
or —SO₂R₅,
R₁₀ is hydrogen,
m is 1, and
n is 0.

13. A washing, cleaning, disinfecting or bleaching composition, comprising
a) 0-50% of an anionic surfactant and/or of a non-ionic surfactant,
b) 0-70% of a builder substance,
c) 1-99% of a peroxide or a peroxide-forming substance, and
d) at least one metal complex of a compound of formula I as described in claim 1 in an amount which, in the liquor, gives a concentration of 0.5-50 mg/litre of liquor when from 0.5 to 20 g/litre of the washing, cleaning, disinfecting or bleaching composition are added to the liquor; the percentages being in each case percentages by weight, based on the total weight of the composition.

14. A solid preparation, comprising
A) from 1 to 99% by weight of a metal complex of a compound of formula I as described in claim 1,
B) from 1 to 99% by weight of a binder,
C) from 0 to 20% by weight of an encapsulating material,
D) from 0 to 20% by weight of a further additive and
E) from 0 to 20% by weight of water.

15. A solid preparation according to claim 14, which is in the form of granules.

16. A method according to claim 1, wherein at least one metal complex of a compound of formula I is added to the oxidising agent.

17. A method according to claim 16, wherein the oxidations relate to the bleaching of spots or stains on textile material or to the prevention of the redeposition of migrating dyes in the context of a washing process, or to the cleaning of hard surfaces.

18. Method according to claim 16, wherein the oxidising agent is a washing, cleaning, disinfecting or bleaching composition.
